(19) United States
(12) Patent Application Publication
(10) Pub. No.: US 2022/0057727 A1
(43) Pub. Date: Feb. 24, 2022

(54) IMAGE FORMING APPARATUS

(71) Applicant: KYOCERA Document Solutions Inc., Osaka (JP)

(72) Inventors: Tamotsu SHIMIZU, Osaka-shi (JP); Masashi FUJISHIMA, Osaka-shi (JP); Akira MATAYOSHI, Osaka-shi (JP); Yasuhiro TAUCHI, Osaka-shi (JP); Yuji TOYOTA, Osaka-shi (JP); Norio KUBO, Osaka-shi (JP)

(73) Assignee: KYOCERA Document Solutions Inc., Osaka (JP)

(21) Appl. No.: 17/403,148

(22) Filed: Aug. 16, 2021

(30) Foreign Application Priority Data
Aug. 21, 2020 (JP) 2020-139929

(51) Int. Cl. G03G 15/02; G03G 15/06; G03G 15/00

(52) U.S. Cl. CPC G03G 15/0266; G03G 15/5037; G03G 15/5041; G03G 15/065

(57) ABSTRACT

An image forming apparatus includes an image carrier, a charging device, an exposure device, a development device, a transferring part, a development bias applying part, an electric current detection part, a density detection part and a bias condition determination part. The bias condition determination part performs a DC voltage determination mode (a DC calibration) determining a reference DC voltage serving as a reference of a DC voltage of a development bias applied to a development roller and a peak-to-peak voltage determination mode (an AC calibration) determining a reference peak-to-peak voltage serving as a reference of a peak-to-peak voltage of an AC voltage of the development bias. When a difference between the reference DC voltages determined the successive DC voltage determination modes exceeds a predetermined threshold value, the bias condition determination part performs the peak-to-peak determination mode.

### INCORPORATION BY REFERENCE

This application is based on and claims the benefit of priority from Japanese patent application No. 2020-139929 filed on Aug. 21, 2020, which is incorporated by reference in its entirety.

### BACKGROUND

The present disclosure relates to an image forming apparatus including a two-component development type development device.

An image forming apparatus for forming an image on a sheet is conventionally provided with a photosensitive drum (an image carrier), a development device and a transferring member. When an electrostatic latent image formed on the photosensitive drum is developed with a toner by the development device, a toner image is formed on the photosensitive drum. The toner image is transferred to the sheet by the transferring member. As the development device of the image forming apparatus, a two-component type development technique using a developer containing a toner and a carrier is known.

In the two-component development technique, the development device includes a development roller, and by applying a development bias in which an AC bias is superposed on a DC bias to the development roller, a suitable toner image is formed. Conventionally, a technique is known, in which an image density of a halftone image is measured while changing the DC bias, and the DC bias capable of obtaining a target image density is selected using the characteristic. On the other hand, when a Vpp (peak-to-peak voltage) of the AC bias is set to be high, the image density increases, the image density is increased, the texture of the halftone image is improved, and a halftone image pitch unevenness which easily occurs at the rotational cycle of the development roller tends to be improved. However, if the Vpp is set to be too high, a leak may occur at a development nip area where the photosensitive drum and the development roller face each other, and a so-called development ghost, in which a printing history of the latest rotation of the development roller appears on the image, deteriorates. In addition, if the Vpp is set to be too low, an image density change (halftone image pitch unevenness) corresponding to the circumferential deflection of the development roller or the photosensitive drum occurs on the halftone image. Therefore, it is necessary to appropriately set the Vpp of the AC bias of the development bias.

There is a technique in which a development current when the test electrostatic latent image is developed is detected, and an image forming condition including a surface potential of a photosensitive drum and the Vpp of the development bias is changed according to the detected development current. Further, there is a technique in which the toner charge amount is estimated from the development current and an amount of the toner on the photosensitive drum, and at least one of the Vpp and the duty of the AC bias is adjusted based on the toner charge amount.

In the conventional technique described above, the Vpp of the AC bias or the like is adjusted to suppress image defects. Here, when the difference between the DC bias and the background potential of the photosensitive drum becomes too large, the development ghost deteriorates, while the half image pitch unevenness is improved. As described above, since the DC bias of the development bias and the Vpp of the AC bias have influence on the image at the same time, it is difficult to obtain a stable image even if only the Vpp is adjusted. That is, even if the Vpp of the AC bias is suitably adjusted, the image defect to be eliminated may be deteriorated depending on the value of the DC bias.

### SUMMARY

In accordance with an aspect of the present disclosure, an image forming apparatus capable of performing an image forming operation in which an image is formed on a sheet includes an image carrier, a charging device, an exposure device, a development device, a transferring part, a development bias applying part, an electric current detection part, a density detection part and a bias condition determination part. The image carrier is provided to be rotated and has a surface on which an electrostatic latent image can be formed and a toner image formed by developing the electrostatic latent image with a toner is carried. The charging device charges the image carrier at a predetermined charged potential. The exposure device is disposed on a downstream side of the charging device in a rotational direction of the image carrier, and exposes the surface of the image carrier charged to the charged potential to form the electrostatic latent image. The development device is disposed so as to face the image carrier at a predetermined nip area on a downstream side of the exposure device in the rotational direction and includes a rotatable development roller having a circumferential surface carrying a developer containing the toner and a carrier. The development roller supplies the toner to the image carrier to form the toner image. The transferring part transfers the toner image carried on the image carrier to the sheet. The development bias applying part is capable of applying a development bias containing a DC voltage on which an AC voltage is superposed. The electric current detection part is capable of detecting a DC component of a development current flowing between the development roller and the development bias applying part. The density detection part is capable of detecting a density of the toner image. The bias condition determination part performs a bias condition determination mode in which, when the development bias is applied to the development roller corresponding to a predetermined measurement electrostatic latent image formed on the image carrier to develop the measurement electrostatic latent image into a measurement toner image, reference voltages serving as references of a peak-to-peak voltage of the AC voltage and the DC voltage of the development bias applied to the development roller in the image forming operation are determined based on the DC component of the development current detected by the electric current detection part or the density of the measurement toner image detected by the density detection part. The bias condition determination part can perform a DC voltage determination mode and a peak-to-peak voltage determination mode as the bias condition determination mode. The DC voltage determination mode determines the reference DC voltage serving as the reference of the DC voltage of the development bias applied to the development roller based on the density of the measurement toner image detected by the density detection part. The peak-to-peak-voltage determination mode determines the reference peak-to-peak voltage serving as the reference of the peak-to-peak voltage of the AC voltage of the development bias applied to the development roller in the image forming operation based on the DC component of the development current detected by the electric current detection part or the density of the measurement toner image detected by the density detection part when the development bias corresponding to the reference DC current is applied to the development roller to develop the measurement electrostatic latent image by the toner into the measurement toner image. The peak-to-peak voltage determination mode is performed when an absolute value of a difference between a first reference DC voltage which is the reference DC voltage determined in the (n)th DC voltage determination mode (n is a natural number) and a second reference DC voltage which is the reference DC voltage determined in (n+1)th DC voltage determination mode is larger than a preset performing determination threshold value.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a sectional view showing an inner structure of an image forming apparatus according to one embodiment of the present disclosure.

FIG. 2 is a sectional view showing a development device and a block diagram showing an electrical structure of a controller according to the embodiment of the present disclosure.

FIG. 3A is a view schematically showing a development operation of the image forming apparatus according to one embodiment of the present disclosure.

FIG. 3B is a view schematically showing a relationship between potentials of an image carrier and a development roller according to the embodiment of the present disclosure.

FIG. 3C is a view schematically showing a relationship between a DC bias and an AC bias of a development bias in the image forming apparatus according to the embodiment of the present disclosure.

FIG. 4 is a flowchart showing a development bias calibration performed in the image forming apparatus according to the embodiment of the present disclosure.

FIG. 5 is a graph showing a relationship between a DC bias and an image density for explaining a DC calibration performed in the image forming apparatus according to the embodiment of the present disclosure.

FIG. 6 is a flowchart of an AC calibration performed in the image forming apparatus according to one embodiment of the present disclosure.

FIG. 7 is a flowchart showing a first approximate expression determination step of the AC calibration performed in the image forming apparatus according to the embodiment of the present disclosure.

FIG. 8 is a flowchart showing a second approximate expression determination step of the AC calibration performed in the image forming apparatus according to the embodiment of the present disclosure.

FIG. 9 is a flowchart showing a part of the second approximate expression determination step of the AC calibration performed in the image forming apparatus according to the embodiment of the present disclosure.

FIG. 10 is a graph showing a relationship between a Vpp and a development current in the AC calibration performed in the image forming apparatus according to the embodiment of the present disclosure.

FIG. 11 is a graph showing a relationship between a Vpp and a development current in the AC calibration performed in the image forming apparatus according to the embodiment of the present disclosure.

FIG. 12 is a graph showing a relationship between a Vpp and a development current in the AC calibration performed in the image forming apparatus according to the embodiment of the present disclosure.

FIG. 13 is a flowchart showing the development bias calibration performed in the image forming apparatus according to the embodiment of the present disclosure.

### DETAILED DESCRIPTION

Hereinafter, an image forming apparatus 10 according to one embodiment of the present disclosure will be described in detail with reference to the attached drawings. In this embodiment, as an example of the image forming apparatus, a color printer of a tandem system is described. The image forming apparatus may be, for example, a copying machine, a facsimile machine, and a multifunctional peripheral having their functions. The image forming apparatus may form a monochromatic image. The image forming apparatus 10 is configured to be able to performing an image forming operation in which an image is formed on a sheet P.

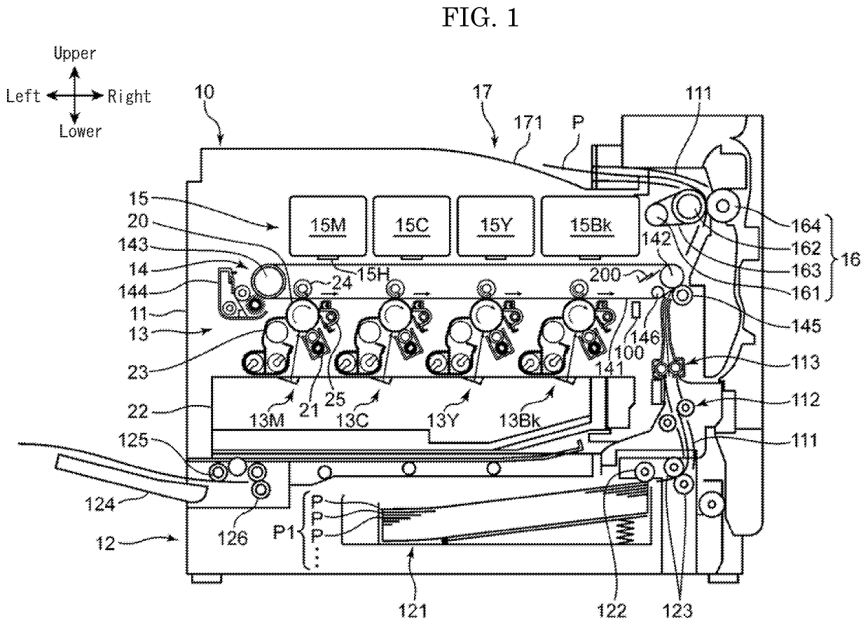

FIG. 1 is a sectional view showing an inner structure of the image forming apparatus 10. The image forming apparatus 10 includes an apparatus main body 11 having a box-shaped housing structure. In the apparatus main body 11, a sheet feeding part 12 which feeds a sheet P, an image forming part 13 which forms a toner image to be transferred to the sheet P fed from the sheet feeding part 12, an intermediate transferring unit 14 (a transferring part) to which the toner image is primarily transferred, a toner replenishing part 15 which replenishes a toner to the image forming part 13, and a fixing part 16 which performs processing for fixing an unfixed toner image formed on the sheet P to the sheet P are provided. Further, in the upper portion of the apparatus main body 11, a sheet discharge part 17 through which the sheet P subjected to the fixing process by the fixing part 16 is discharged.

On a suitable portion of the upper face of the apparatus main body 11, an operation panel (not shown) for input operation of an output condition for the sheet P or the like is provided. The operation panel includes a power supply key, a touch panel and various operation keys for inputting the output condition.

In the apparatus main body 11, a sheet conveyance path 111 extending in the upper-and-lower direction is formed on the right side of the image forming part 13. On the sheet conveyance path 111, a conveyance rollers pairs 112 is provided at a suitable position. A registration rollers pair 113 which corrects a skew of the sheet P and feeds the sheet P to a secondary transferring nip area, describe below, at a suitable timing is provided on the downstream side of the nip area on the sheet conveyance path 111. The sheet conveyance path 111 is a conveyance path along which the sheet P is conveyed from the sheet feeding part 12 to the sheet discharge part 17 through the image forming part 13 and the fixing part 16.

The sheet feeding part 12 includes a sheet feeding tray 121, a pickup roller 122 and a sheet feeding rollers pair 123. The sheet feeding tray 121 is detachably attached to the lower portion of the inside of the apparatus main body 11, and stores a sheet bundle P1 containing the stacked sheets S. The pickup roller 122 feeds the uppermost sheet P of the sheet bundle P1 stored in the sheet feeding tray 121 one by one. The sheet feeding rollers pair 123 feeds the fed sheet P by the pickup roller 122 to the sheet conveyance path 111.

The sheet feeding part 12 includes a manual sheet feeding part provided on the left side face of the apparatus main body 11 as shown in FIG. 1. The manual sheet feeding part includes a manual sheet feeding tray 124, a pickup roller 125 and a sheet feeding rollers pair 126. The manual sheet feeding tray 124 is a tray on which the sheet P is placed manually, and is opened to the side face of the apparatus main body 11 when the sheet P is fed manually, as shown in FIG. 1. The pickup roller 125 feeds the sheet P placed on the manual sheet feeding tray 124. The sheet feeding rollers pair 126 feeds the sheet P fed by the pickup roller 125 to the sheet conveyance path 111.

The image forming part 13 forms a toner image to be transferred to the sheet P, and includes a plurality of image forming units which form the toner images of different colors. In this embodiment, the image forming unit includes a magenta unit 13M using a magenta (M) color developer, a cyan unit 13C using a cyan (C) color developer, a yellow unit 13Y using a yellow (Y) color developer, and a black unit 13Bk using a black (Bk) color developer, which are sequentially disposed from the upstream side to the downstream side (from the left side to the right side as shown in FIG. 1) in a rotational direction of an intermediate transfer belt 141 described later. Each of the units 13M, 13C, 13Y, and 13Bk includes a photosensitive drum 20 (an image carrier), and a charging device 21, a development device 23, a primary transferring roller 24, and a cleaning device 25 which are disposed around the photosensitive drum 20. An exposure device 22 commonly used for the units 13M, 13C, 13Y and 13Bk is disposed below the image forming units.

The photosensitive drum 20 is driven to rotate around an axis, and has a cylindrical surface which allows a formation of an electrostatic latent image and carries a toner image in which the electrostatic latent image is developed by a toner. As an example of the photosensitive drum 20, a known amorphous silicon (α-Si) photosensitive drum or an organic photoconductor drum (OPC) may be used. The charging device 21 uniformly charges the surface of the photosensitive drum 20 to a predetermined charged potential. The charging device 21 includes a charging roller and a charging cleaning brush for removing the toner remaining on the charging roller. The exposure device 22 is disposed on the downstream side of the charging device 21 in the rotational direction of the photosensitive drum 20, and includes various optical components as a light source, a polygon mirror, a reflection mirror, and a deflection mirror. The exposure device 22 forms the electrostatic latent image by irradiating and exposing the surface of the photosensitive drum 20 uniformly charged to the charged potential with light modulated based on image data (predetermined image information).

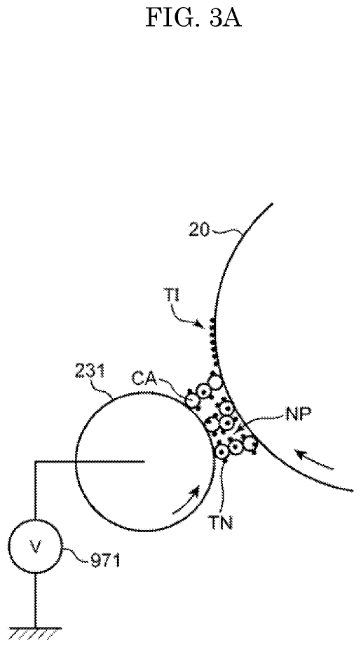

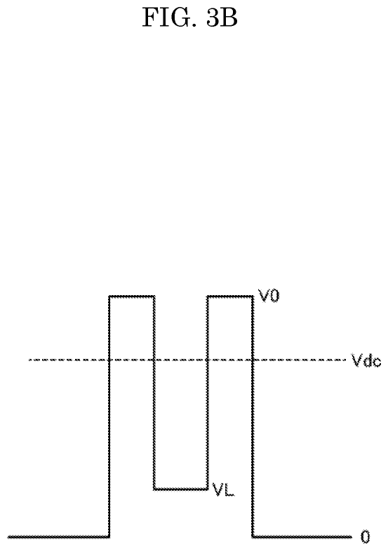

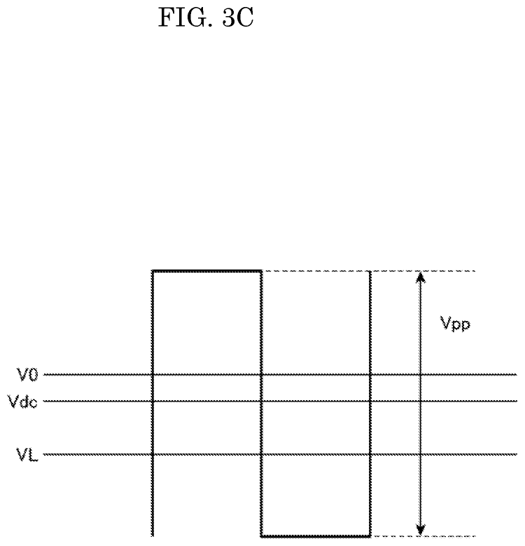

The development device 23 is disposed so as to face the photosensitive drum 20 at a predetermined development nip area NP (FIG. 3A) on the downstream side of the exposure device 22 in the rotational direction of the photosensitive drum 20. The development device 23 includes a development roller 231. The development roller 231 has a circumferential surface which is rotated and carries a developer containing the toner and a carrier, and forms the toner image by supplying the toner to the photosensitive drum 20.

The primary transferring roller 24 forms the nip area between the photosensitive drum 20 and the intermediate transfer belt 141 provided in the intermediate transferring unit 14. Furthermore, the primary transferring roller 24 primarily transfers the toner image on the photosensitive drum 20 to the intermediate transferring belt 141. The cleaning device 25 cleans the circumferential surface of the photosensitive drum 20 after the toner image is transferred.

The intermediate transferring unit 14 is disposed in a space provided between the image forming part 13 and the toner replenishing part 15, and includes the intermediate transferring belt 141, a drive roller 142 rotatably supported by a unit frame (not shown), a driven roller 143, a backup roller 146, and a density sensor 100. The intermediate transferring belt 141 is an endless belt-like rotating body, and is stretched around the drive roller 142, the driven roller 143, and the backup roller 146 such that the circumferential surface thereof comes into contact with the circumferential surfaces of the photosensitive drums 20. The intermediate transferring belt 141 is traveled by the rotation of the driving roller 142. A belt cleaning device 144 for removing the toner remaining on the circumferential surface of the intermediate transferring belt 141 is disposed near the driven roller 143. The density sensor 100 (a density detection part) is disposed on the downstream side of the units 13M, 13C, 13Y and 13Bk so as to face the intermediate transferring belt 141, and detects a density of the toner image formed on the intermediate transferring belt 141 by a reflected light (a reflection type). In another embodiment, the density sensor 100 may detect a density of the toner image on the photosensitive drum 20 or a density of the toner image fixed on the sheet P.

A secondary transfer roller 145 is disposed outside the intermediate transferring belt 141 so as to face the drive roller 142. The secondary transferring roller 145 is pressed against the circumferential surface of the intermediate transferring belt 141 to form a transferring nip area between the drive roller 142 and the intermediate transferring belt 141. The toner image primarily transferred to the intermediate transferring belt 141 is secondarily transferred to the sheet P fed from the sheet feeding part 12 at the transferring nip area. That is, the intermediate transferring unit 14 and the secondary transferring roller 145 function as a transferring unit which transfers the toner image carried on the photosensitive drum 20 to the sheet P. A roll cleaner 200 for cleaning the circumferential surface of the drive roller 142 is disposed on the drive roller.

The toner replenishment part 15 stores the toner used for the image forming operation, and in this embodiment, includes a magenta toner container 15M, a cyan toner container 15C, a yellow toner container 15Y, and a black toner container 15Bk. The toner containers 15M, 15C, 15Y, and 15Bk store replenishment toners of the colors of M, C, Y, and Bk, respectively. The toner of each color is replenished through a toner discharge port 15H formed on the bottom surface of each container to each the development device 23 of the image forming units 13M, 13C, 13Y and 13Bk corresponding to the colors of M, C, Y and Bk.

The fixing part 16 includes a heating roller 161 in which a heating source is stored, a fixing roller 162 disposed opposite to the heating roller 161, a fixing belt 163 stretched between the fixing roller 162 and the heating roller 161, and a pressure roller 164 disposed opposite to the fixing roller 162 to form a fixing nip area between the fixing belt 163 and the pressure roller 163. The sheet P conveyed to the fixing part 16 is passed through the fixing nip area, and heated and pressurized. Thus, the toner image transferred to the sheet P at the transferring nip area is fixed to the sheet P.

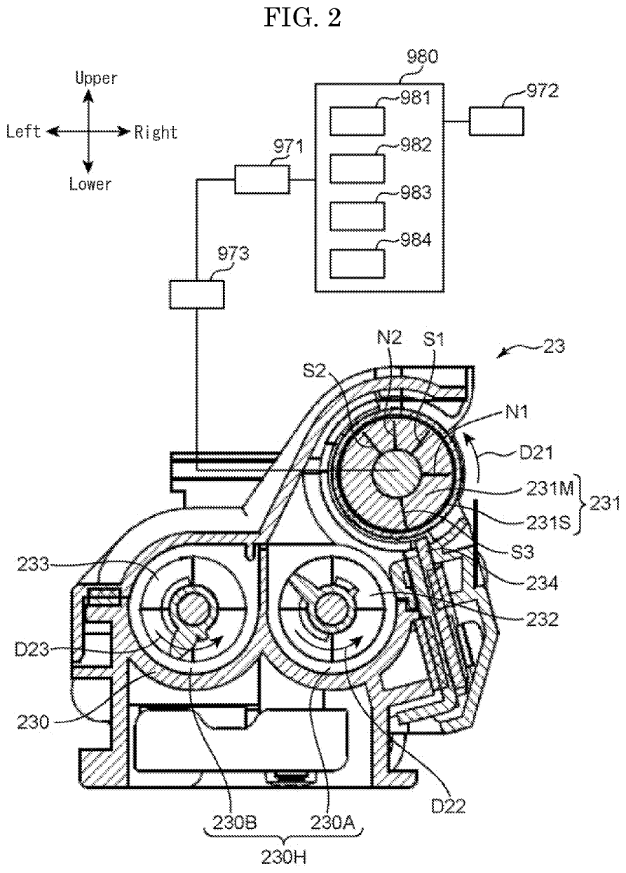

The discharge part 17 is formed by a recessed top portion of the apparatus main body 11, and a discharge tray 171 on which the discharged sheet P is received is formed on the bottom portion of the recessed top portion. The sheet P subjected to the fixing process is discharged to the discharge tray 171 along the sheet conveyance path 111 extended from the upper portion of the fixing part 16.

<Development Device> FIG. 2 is a block diagram showing a section of the development device 23 and an electrical configuration of a controller 980 according to the present embodiment. The development device 23 includes a development housing 230, a development roller 231, a first screw feeder 232, a second screw feeder 233 and a regulating blade 234. The development device 23 adopts a two-component development system.

The development housing 230 includes a developer storage part 230H. The developer storage part 230H stores a two-component developer containing the toner and the carrier. The developer storage part 230H has a first conveyance part 230A and a second conveyance part 230B. In the first conveyance part 230A, the developer is conveyed along a first conveyance direction (a direction perpendicular to a paper plane on which FIG. 2 is drawn, a direction from the rear side to the front side) from one axial end to the other axial end of the development roller 231. The second conveyance part 230B communicates with the first conveyance part 230A at both the axial ends, and the developer is conveyed along a second conveyance direction opposite to the first conveyance direction in the second conveyance part 230B. The first screw feeder 232 and the second screw feeder 233 are rotated in the directions shown by the arrows D22 and D23 in FIG. 2, and convey the developer along the first conveyance direction and the second conveyance direction, respectively. Especially, the first screw feeder 232 supplies the developer to the development roller 231 while conveying the developer along the first conveyance direction.

The development roller 231 is disposed at the development nip area NP (FIG. 3A) so as to face the photosensitive drum 20. The development roller 231 includes a rotating sleeve 231S and a magnet 231M fixedly disposed inside the sleeve 231S. The magnet 231M has a S1 pole, a N1 pole, a S2 pole, a N2 pole and a S3 pole. The N1 pole functions as a main pole, the S1 pole and the N2 pole function as a conveyance pole, and the S2 pole functions as a release pole. The S3 pole functions as a pulling up pole and a regulating pole. As an example, the S1 pole, the N1 pole, the S2 pole, and the N2 pole and the S3 pole have magnetic flux density of 54 mT, 96 mT, 35 mT, 44 mT and 45 mT, respectively. The sleeve 231S of the development roller 231 is rotated in the direction shown by the arrow D21 in FIG. 2. The development roller 231 is rotated, is supplied with the developer in the development housing 230, carries the developer and supplies the toner to the photosensitive drum 20. In the present embodiment, the development roller 231 rotates in the same direction (a with direction) at a position facing the photosensitive drum 20. In the axial direction (the width direction) of the development roller 231, a range in which a magnetic brush of the two-component developer is formed has a length of 304 mm, for example.

The regulating blade 234 is disposed at an interval to the development roller 231, and regulates a layer thickness of the developer supplied on the circumferential surface of the development roller 231 from the first screw feeder 232.

The image forming apparatus 10 including the development device 23 further includes a development bias applying part 971, a drive part 972, an electric current meter 973 (an electric current detection part) and the controller 980. The controller 980 includes a central processing unit (CPU), a read only memory (ROM) storing control program and a random access memory (RAM) used for a working area of the CPU.

The development bias applying part 971 includes a DC current source and an AC current source, and applies a development bias in which an AC voltage (an AC bias) is superposed on a DC voltage (a DC bias) to the development roller 231 of the development device 23.

The drove part 972 includes a motor and a gear train transmitting a torque of the motor, and rotates the development roller 231, the first screw feeder 232 and the second screw feeder 233 in the development device 23 in addition to the photosensitive drum 20 at the development operation depending on the control signal from a drive control part 981 described above.

The electric current meter 973 detects an AC current (an AC component of a development current) flowing between the development roller 231 and the development bias applying part 971.

The controller 980 causes the CPU to execute the control program stored in the ROM, and functions to include the drive control part 981, a bias control part 982, a storage part 983 and a calibration performing part 984 (a bias condition determination part).

The drive control part 981 controls the drive part 972 to rotate the development roller 231, the first screw feeder 232 and the second screw feeder 233. Further, the drive control part 981 control a drive mechanism (not shown) to rotate the photosensitive drum 20.

The bias control part 982 controls the development bias applying part 971 to provide a potential difference in the DC voltage and the AC voltage between the photosensitive drum 20 and the development roller 231 when the toner is supplied to the photosensitive drum 20 from the development roller 231 (when the image forming operation is performed). The toner is moved from the development roller 231 to the photosensitive drum 20 owing to the potential difference.

The storage part 983 stores various information referenced by the drive control part 981, the bias control part 982 and the calibration performing part 984. As an example, a value of the development bias adjusted depending on a rotational speed of the development roller 231 and an environment condition may be stored. The storage part 983 also stores a printing ratio and a number of lines set corresponding to each of the measurement toner images formed on the photosensitive drum 20. The data stored in the storage part 983 may be a graph or a table.

The calibration performing part 984 performs a development bias calibration including a DC calibration and an AC calibration described below.

Further, the calibration performing part 984 forms a plurality of measurement toner images on the photosensitive drum 20 while controlling the photosensitive drum 20, the charging device 21, the exposure device 22 and the development device 23 in the AC calibration. Then, the calibration performing part 984 determines a reference peak-to-peak voltage which is a reference peak-to-peak voltage of an AC voltage of the development bias applied to the development roller 231 at the image forming operation, based on a DC current detected by the electric current meter 973 when a predetermined measurement electrostatic latent image formed on the photosensitive drum 20 is developed into a measurement toner image by applying the development bias corresponding to the measurement electrostatic latent image. In the DC calibration after performing the AC calibration or the image forming operation, the above reference peak-to-peak voltage may be used as it is, or a voltage obtained by multiplying the reference peak-to-peak voltage by a predetermined safety factor may be used.

<Development Operation> FIG. 3A is a view schematically showing the development operation of the image forming apparatus 10 according to the present embodiment, FIG. 3B is a view schematically showing a relationship of a potential between the photosensitive drum 20 and the development roller 231. FIG. 3C is a view schematically showing a relationship between the DC bias and the AC bias of the development bias. With reference to FIG. 3A, the development nip area NP is formed between the development roller 231 and the photosensitive drum 20. The toner TN and the carrier CA carried on the development roller 231 form a magnetic brush. At the development nip area NP, the toner TN is supplied to the photosensitive drum 20 from the magnetic brush, and the toner image TI is formed. With reference to FIG. 3B, the surface of the photosensitive drum 20 is charged to a background potential V0 (V) by the charging device 21. Then, when the photosensitive drum 20 is emitted with exposure light by the exposure device 22, the surface potential of the photosensitive drum 20 is changed from the background potential V0 (V) (a non-image formed area) to an image formed area potential VL (V) (an image formed area) at the maximum according to the image to be printed. On the other hand, with reference to FIG. 3C, the development roller 231 is applied with a DC voltage Vdc (a DC bias) of the development bias, in which an AC voltage (an AC bias) is superposed on the DC voltage Vdc. As an example, as shown in FIG. 3C, the AC voltage contains a periodical rectangular wave, and the peak-to-peak voltage (Vpp) has an amplitude exceeding the background voltage V0 and the image formed area potential VL of the photosensitive drum 20.

In such a reversal development type, a potential difference between the surface potential V0 and the DC current component Vdc of the development bias shows a potential difference capable of suppressing a toner fogging on the background area of the photosensitive drum 20. On the other hand, a potential difference between the surface potential VL after the exposing and the DC component Vdc of the development bias shows a development potential difference by which the plus charged toner is moved to the image formed area of the photosensitive drum 20. Further, the AC component (the AC bias) of the development bias applied to the development roller 231 accelerates the moving of the toner from the development roller 231 to the photosensitive drum 20.

<Development Bias Calibration> Conventionally, a technique is known, in which an image density of a halftone image is measured while changing the above DC bias and a DC bias capable of being obtained a target image density is selected using the characteristic. On the other hand, when the Vpp (the peak-to-peak voltage) of the AC bias is set to be high, the image density increases, the texture of the halftone image is improved, and a halftone image pitch unevenness which easily occurs at the rotational cycle of the development roller 231 tends to be improved. However, if the Vpp is set to be too high, a leak may occur at the development nip area NP where the photosensitive drum 20 and the development roller 231 face each other, and a so-called development ghost, in which a printing history of the latest rotation of the development roller appears on the image, deteriorates. In addition, if the Vpp is set to be too low, an image density change (halftone image pitch unevenness) corresponding to the circumferential deflection of the development roller or the photosensitive drum occurs on the halftone image. Therefore, it is necessary to appropriately set the Vpp of the AC bias in the development bias. Further, when a difference between the above DC bias Vdc and the background potential V0 of the photosensitive drum 20 becomes too high, although the development ghost deteriorates, the halftone image pitch unevenness is improved. As described above, since the DC bias of the development bias and the Vpp of the AC bias have influence on the image at the same time, it is difficult to obtain a stable image even if only the Vpp is adjusted. That is, even if the Vpp of the AC bias is suitably adjusted, the image defect to be eliminated may be deteriorated depending on the value of the DC bias. Then, the inventors of the present disclosure newly have found “a development bias calibration” allowing stably setting the DC bias of the development bias and the peak-to-peak voltage of the AC bias individually at a suitable timing before the image forming operation in the image forming apparatus 10 including the development device 23 of a two-component development type.

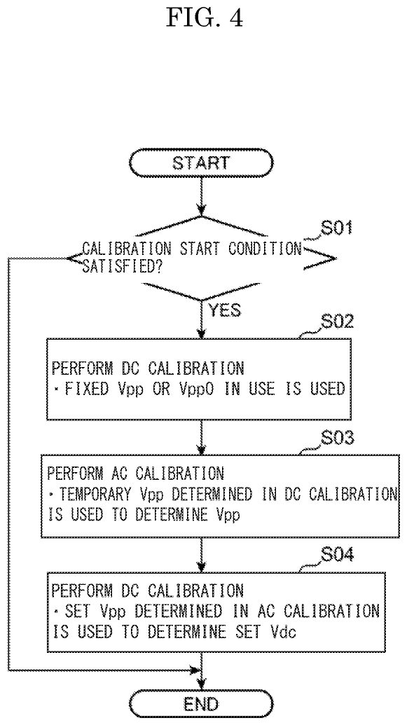

FIG. 4 is a flowchart showing the development bias calibration performed by the calibration performing part 984 in the image forming apparatus 10 according to the present embodiment. The development bias calibration is performed at the non-image forming operation where the image is not formed on the sheet P.

Specifically, for the performing of the development bias calibration, the calibration performing part 984 determines whether a predetermined calibration start condition is satisfied (step S01). As an example, when a number of printed sheets in the image forming apparatus 10 exceeds a predetermined threshold number, the calibration performing part 984 performs the development bias calibration performing part 984 performs the development bias calibration (Yes in step S01). The calibration start condition may be set such that the development bias calibration is performed when a surrounding environment (a humidity and a temperature) of the image forming apparatus 10 is remarkably changed. When the above calibration start condition is not satisfied, the calibration performing part 984 completes the processing without performing the development bias calibration, and waits for the next performing timing.

When the development bias calibration is started, the calibration performing part 984 performs the DC calibration (step S02). The DC calibration is a mode where a suitable DC bias (a temporally Vdc, a temporary reference DC voltage, a reference voltage) applied for the next AC calibration is determined. Here, the DC calibration is performed by using a fixed Vpp previously set and stored in the storage part 983 or the Vpp (Vpp0) used in the latest image forming operation.

The calibration performing part 984 performs the AC calibration after performing the DC calibration (step S03). Here, the AC calibration is performed using the temporary Vdc determined in the above DC calibration. In the AC calibration, a Vpp (a reference peak-to-peak voltage) of a suitable AC bias capable of obtaining a desired image density and image quality in the following image forming operation is determined.

Next, the calibration performing part 984 performs the DC calibration again (step S04). In the DC calibration, the Vpp used in the latest AC calibration is used, and a suitable DC bias (Vdc) (a reference DC voltage, a reference voltage) capable of obtaining a desired image density and image quality in the following image forming operation is determined.

In other words, in the present embodiment, in the first DC calibration, a temporary Vpp is used to determine a temporally Vdc, and in the AC calibration, a true Vpp to be originally set is determined using the temporary Vdc. Then, in the second DC calibration, the true Vdc is determined using the true Vpp. As described above, the Vpp and the Vdc are determined at the two steps so that it becomes possible to obtain an image having no failure for a long time of period.

As described later, the development bias calibration is not limited to the above manner in which the DC calibration and the DC calibration are combined. Based on various conditions in the image forming apparatus 10, the DC calibration or the AC calibration may be performed individually. Or, in the present embodiment, the calibration performing part 984 determines a suitable Vpp based on the development current measured by the electric current meter 973, and determines a suitable Vdc based on the image density detected by the density sensor 100 (an optical sensor). This is caused by a fact that a condition for determining the Vpp is set based on that a saturated density of the image is stabilized and a condition for determining the Vdc is set based on that a level (a magnitude) of the saturated density is set. This selection way makes it possible to make the image quality more stable.

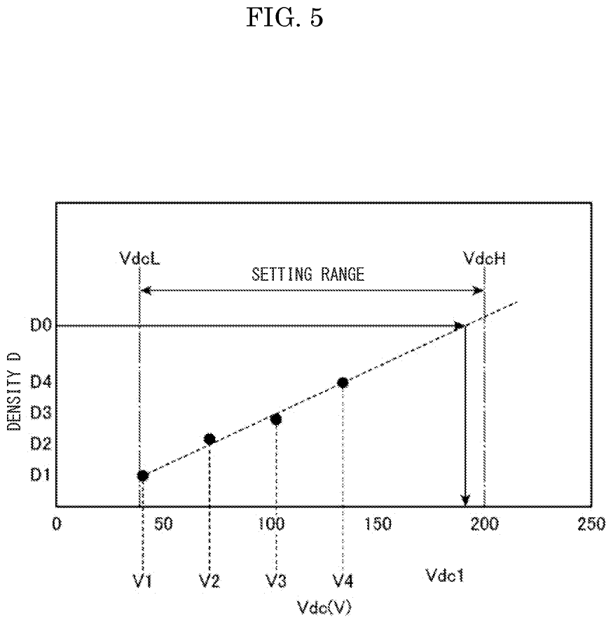

When the Vpp is determined based on the condition that the saturated density of the image is stabilized, it is difficult for the density sensor 100 consisting of the optical sensor to accurately measure the image density in the density saturated region, and it is necessary to measure the density saturation state of the image by a method other than the image density. Accordingly, the inventors of the present disclosure have newly found a method for determining the Vpp based on the development current. Hereinafter, each of the above DC calibration and the above AC calibration will be described in detail.

<DC Calibration> FIG. 5 is a graph showing a relationship between a DC vias Vdc and an image density D for explaining the DC calibration performed in the image forming apparatus 10 according to the present embodiment. When the DC calibration is started (step S02, S04 in FIG. 4), the calibration performing part 984 changes the DC bias (Vdc) of the development bias to V1, V2, V3 and V4 sequentially with setting the surface potential of the photosensitive drum 20 to VL to form measurement toner images corresponding to the DC biases on the photosensitive drum 20 and then to transfer the measurement toner images to the intermediate transferring belt 141. Then, the density of each measurement toner images is measured by the density sensor 100. The image densities at this time (or a reflection density measured by the density sensor 100, or an output voltage of the density sensor 100) are defined as D1, D2, D3 and D4 respectively. Then, as shown in FIG. 5 in which the horizontal axis represents the above DC bias Vdc and the vertical axis represents the image density, a relationship between the Vdc and the image density D is shown by a linear approximate expression. Based on the approximate expression, it becomes possible to determine a Vdc (a Vdc1, a temporary reference DC voltage, a reference DC voltage) capable of obtaining a desired target image density D0 at the image forming operation. If the obtained Vdc1 is lower than a previously set lower limit (VdcL: 40 V, for example), the Vdc1 is replaced with the VdcL. In the same manner, if the obtained Vdc1 is larger than a previously set upper limit (VdcH: 200 V, for example), the Vdc1 is replaced with the VdcH. As described above, in the DC calibration performed in step S02 in FIG. 4, the DC calibration is performed using the fixed Vpp previously stored in the storage part 983 or the Vpp (Vpp0) used in the latest image forming operation. On the other hand, in the DC calibration performed in step S04 in FIG. 4, the Vpp determined in the latest AC calibration (step S02 in FIG. 4) is used. For the other parameters of the AC bias, the same values as the image forming operation are used. The Vdc1 determined in the above manner is used as the temporary reference DC voltage or the reference DC voltage. The graph shown in FIG. 5 may be drawn with the horizontal axis representing ΔV (Vdc−VL).

<Change in Amount of Attached Toner and Change in Development Bias> When the charged amount of the toner in the development device 23 is changed or the development gap is changed owing to vibration of the development roller 231, both the above DC bias and the above AC bias have a characteristic that a moving force F (=an electric charge Q of the toner×an intensity E of an electric field) applied to the toner is changed and an image density is changed. However, the DC bias and the AC bias have different characteristics from each other. In the case of the AC bias, when the Vpp (the peak-to-peak voltage) is increased, an image density increases, but eventually the image density hardly increases, and when the Vpp (the peak-to-peak voltage) is further increased, the image density decreases. On the other hand, when the development potential difference (Vdc−VL) in the DC bias is increased, the image density continues to increase, and eventually the amount of increase in the image density decreases, but the decrease in the image density as in the case of the AC bias is not confirmed. This seems be caused by a fact that the AC electric field forms a bidirectional electric field (a reciprocating electric field) between the photosensitive drum 20 and the development roller 231 at the development nip area, while the DC electric field forms a unidirectional electric field.

In detail, the reciprocating electric field of the AC bias is constituted by two electric fields opposite to each other containing a development electric field in which the toner is supplied from the development roller 231 to the photosensitive drum 20 and a collection electric field in which the toner is collected from the photosensitive drum 20 to the development roller 231. Then, when the Vpp is increased, the intensity of both the electric fields is increased, but the supply amount of the toner owing to the development electric field becomes the maximum eventually. Thereafter, when the Vpp is further increased, a collection amount of the toner is increased owing to the increase in the intensity of the collection electric field but the supply amount of the toner owing to the development electric field is already maximum. As result, depending on a relationship between the toner supply and the toner collection between the photosensitive drum 20 and the development roller 231, the final toner development amount is decreased in response to the increase of the Vpp.

<Relationship between Vpp and Development Bias> As described above, a relationship between the DC bias and the AC bias, and the development amount of the toner can be obtained, but it is not sufficiently known that what kind of behavior of the development current flowing between the development roller 231 and the development bias applying part 971 is exhibited.

It is seemed that this is because the development current generated in the development nip area NP contains “a toner moving current flowing due to the moving of the toner”, “a magnetic brush current flowing through the magnetic brush of the developer in the image formed area (an image formed area magnetic brush current)”, and “a magnetic brush current flowing through the magnetic brush of the developer in the non-image formed area (a non-image formed area magnetic brush current). Because the toner moving current changes depending on the moving amount of the toner, the toner moving current increases and then decreases as the Vpp is increased. However, the image formed area magnetic brush current tends to be increased with the increase of the Vpp because it is the current flowing through the magnetic brush in the development nip area NP. Further, the non-image formed area magnetic brush current tends to increase the current in the opposite direction at both the longitudinal end portions of the image formed area as the Vpp is increased. Therefore, it is not sufficiently known what kind of behavior of the development current, which is complicatedly affected by the sum of the toner moving current, the image formed area magnetic brush current and the non-image formed area magnetic brush current, is exhibited with the increase of the Vpp.

Then, the inventors of the present disclosure carried out experiments to confirm the behavior of the development current when the Vpp of the AC bias of the development bias is increased, and has newly found that there is a plurality of patterns in the development current behavior. That is, when the Vpp of the AC bias is increased, the development current (the DC current) increases, but there is various pattern of the development current containing a pattern in which the development current eventually reaches a change point at which the inclination of the increase is changed and then is gradually increases, a pattern in which the development current decreases from the change point conversely.

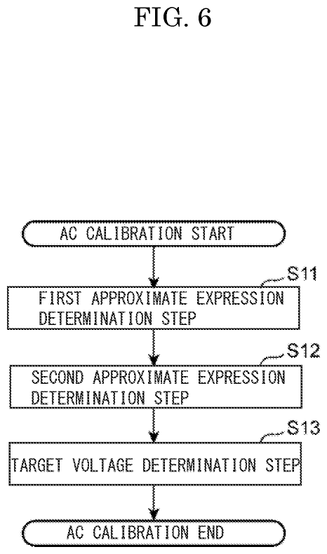

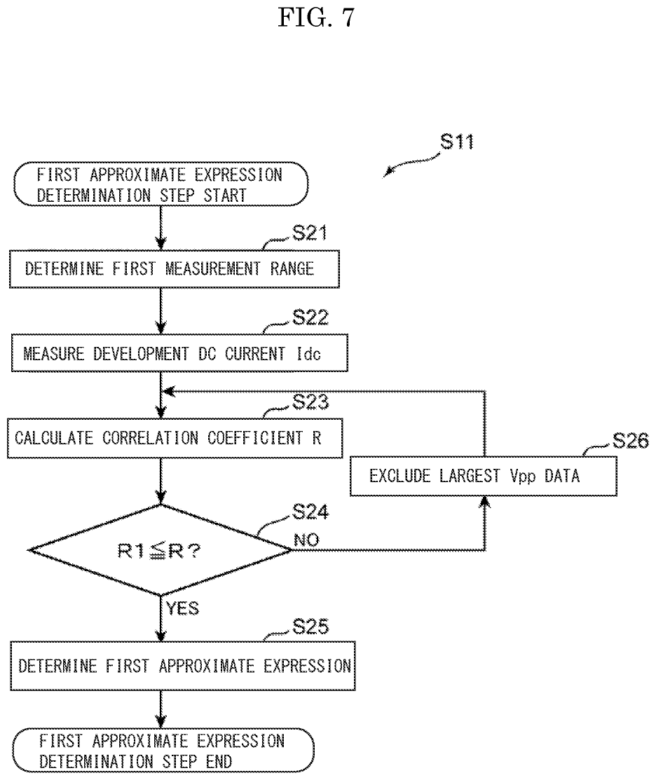

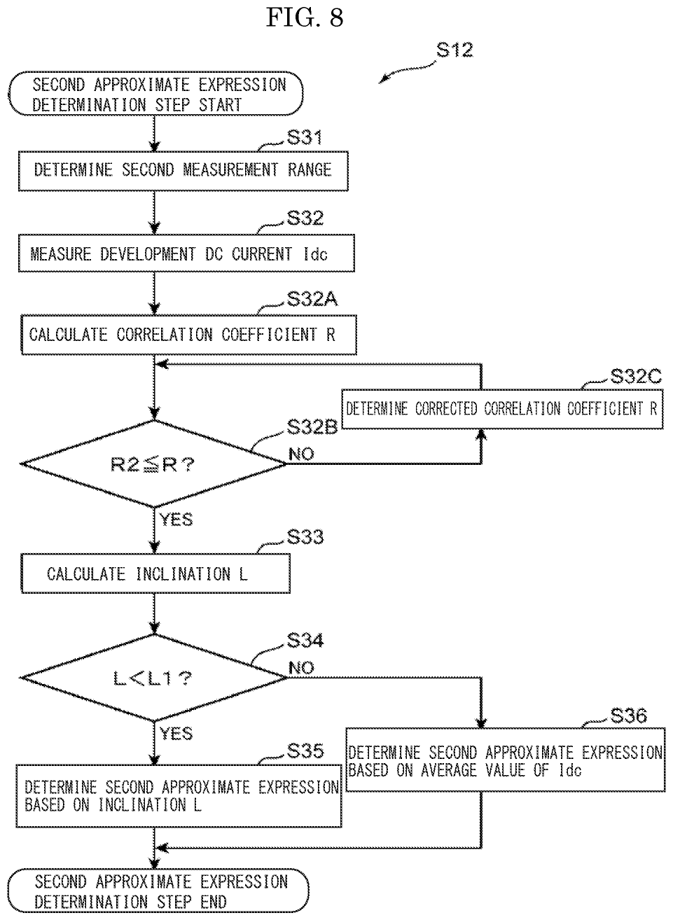

The inventors of the present disclosure have newly focused on that the Vpp of the AC bias is set to a region where a change of an image density is small based on the patterns of the development current. As a result, even if the charged amount of the toner and the development gap are changed, it becomes possible to decrease the change of an image density. Hereinafter, the AC calibration for setting such the Vpp will be described in detail.

<AC calibration> FIG. 6 is a flowchart showing the AC calibration performed in the image forming apparatus 1 according to the present embodiment. FIG. 7 is a flowchart showing a first approximate expression determination step (a first approximate expression determination processing) of the AC calibration performed in the image forming apparatus 1 according to the present embodiment. FIG. 8 is a flowchart showing a second approximate expression determination step (a second approximate expression determination processing) of the AC calibration performed in the image forming apparatus 1 according to the present embodiment.

In the present embodiment, in step S02 in FIG. 4, the calibration performing part 984 performs the AC calibration. The AC calibration is a mode in which a reference peak-to-peak voltage (a target voltage) serving as a reference of the peak-to-peak voltage (Vpp) of the AC voltage of the development bias applied to the development roller 231 in the image forming operation is determined. As described above, the reference peak-to-peak voltage determined by the AC calibration is set such that a change amount of the development current is small, in other words, the change of the toner development amount is small even if the peak-to-peak voltage is changed.

When the AC calibration is started, the calibration performing part 984 performs the first approximate expression determination step (step S11 in FIG. 6), the second approximate expression determination step (step S12 in FIG. 6) and a target voltage determination step (S13 in FIG. 6) (a reference voltage determination processing) in the order.

With reference to FIG. 7, the first approximate expression determination step will be described. When the first approximate expression determination step is started, the calibration performing part 984 obtains information about a first measurement range stored in the storage part 983. The first measurement range is information relating to a range and an interval of the Vpp of the AC voltage applied to the development roller 231 in the first approximate expression determination step. In the present embodiment, as an example, the information relating to the four first measurement peak-to-peak voltages is obtained by the calibration execution part 984. As a result, the first measurement range in the first approximate expression determination step is determined (step S21).

Next, the calibration performing part 984 forms a measurement electrostatic latent image by a solid image on the photosensitive drum 20, and applies the development bias to the development roller 231 to develop the measurement electrostatic latent image into a measurement toner image. Specifically, in the same manner as the image forming operation, the photosensitive drum 20 is rotated, and then the charging device 21 charges the circumferential surface of the photosensitive drum 20 at 250 V uniformly. As an example, a charged range of the photosensitive drum 20 in the axial direction (a width direction) is set to 322 mm. Then, the exposure device 22 emits exposure light on the photosensitive drum 20 such that a potential of a part of the photosensitive drum 20 is decreased to 10 V and the measurement electrostatic latent image is formed on the photosensitive drum 20. In the present embodiment, for the sheet width of 297 cm (a length of the longer side of the A4 size), a width of the measurement electrostatic latent image is set to 287 mm, a width of the magnetic brush of the development roller is set to 304 mm, and regions between the axial ends of the magnetic brush and the axial ends of the measurement electrostatic latent image are a region where the non-image formed area magnetic brush current flows.

On the other hand, the development roller 231 is applied with a DC voltage of 150 V on which an AC voltage having a frequency of 10 kHz and a duty ratio of 50% is superposed. The Vpp of the AC voltage is set to the four measurement peak-to-peak voltages in the order. As a result, for each first measurement peak-to-peak voltage, when the above measurement electrostatic latent image is developed into the measurement toner image by the development roller 231, the electric current meter 973 measures a DC component (a DC current Idc) of the development current flowing between the development roller 231 and the development bias applying part 971 (step S22). As a result, the four development currents corresponding to the four first measurement peak-to-peak voltages are obtained, and four sets of data relating to the first measurement peak-to-peak voltage and the development current are obtained. The development current may be preferably calculated using an average current for one rotating of the development roller 231, more preferably using an average current for integral multiple of one rotating of the development roller 231.

Next, the calibration performing part 984 obtains a linear progression expression showing a relationship between the above four first measurement peak-to-peak voltages and the four development currents, and calculates a correlation coefficient R thereof (step S23). As an example, the calibration performing part 984 calculates the linear expression by the least squares method and obtains the correlation coefficient R.

Next, the calibration execution part 984 compares the correlation coefficient R obtained as described above with the threshold value R1 previously stored in the storage part 983 (step S24). As an example, the threshold R1 is set to 0.90. If the threshold value R1 is smaller than or equal to the correlation coefficient R (YES in step S24), the calibration performing part 984 determines that the above linear regression expression is set to the first approximate expression (step S25). On the other hand, if the threshold value R1 is larger than the correlation coefficient R in step S24 (NO in step 24), the calibration performing part 984 calculates the correlation coefficient R again based on the remaining three data in a state in which the data of the largest Vpp is removed from the four sets of data. Thereafter, the calibration performing part 984 performs steps S24 and S25 in the same manner as described above. If the relationship that the threshold R1 is smaller than or equal to the correlation coefficient R is not satisfied even after the data of the largest Vpp is removed in step S26, the calibration execution part 984 may repeat the step by further removing one of the data, or may suspend the performing of the AC calibration and incorporate the result of the latest performed AC calibration.

As described above, when the first approximate expression determination step is completed, the second approximate expression determination step is started. With reference to FIG. 8, the second approximate expression determination step will be described in detail. When the second approximate expression determination step is started, the calibration performing part 984 obtains information about the second measurement range stored in the storage part 983. The second measurement range is information relating to a range and an interval of a Vpp of an AC voltage applied to the development roller 231 in the second approximate expression determination step. In this embodiment, as an example, the information relating to the three second measurement peak-to-peak voltages are obtained by the calibration performing part 984. As a result, the second measurement range in the second approximate expression determination step is determined (step S31). The smallest value of the second measurement range (the three second measurement peak-to-peak voltages) is set larger than the largest value of the first measurement range (the four first measurement peak-to-peak voltages).

Next, the calibration performing part 984 forms the measurement electrostatic latent image on the photosensitive drum 20 in the same manner as step S12 in FIG. 7, applies the development bias to the development roller 231, and develops the measurement electrostatic latent image into the measurement toner image. At this time, the development roller 231 is applied with a DC voltage of 150 V on which an AC voltage having a frequency of 10 kHz and a duty ratio of 50% is superposed, and the Vpp of the AC voltage is set to the three second measurement peak-to-peak voltages in the order. As a result, for each second measurement peak-to-peak voltage, when the measurement electrostatic latent image is developed by the development roller 231, the electric current meter 973 measures a DC component (a DC current Idc) of the development current flowing between the development roller 231 and the development bias applying part 971 (step S32). As a result, three development currents corresponding to the three second measurement peak-to-peak voltages are obtained, and three sets of data relating to the second measurement peak-to-peak voltage and the development current are obtained.

The calibration performing part 984 calculates a correlation coefficient R in the same manner as the first approximate expression determination step (step S32A). Then, the calibration performing part 984 compares the correlation coefficient R with the threshold value R2 previously stored in the storage part 983 (step S32B). As an example, the threshold value is set to 0.90. If the threshold value R2 is smaller than or equal to the correlation coefficient R (YES in step 32B), the calibration performing part 984 advances the step to the next step. On the other hand, if the R2 is larger than R in step S32B (NO in step S32B), the calibration performing part 984 determines a corrected correlation coefficient R in step S32C.

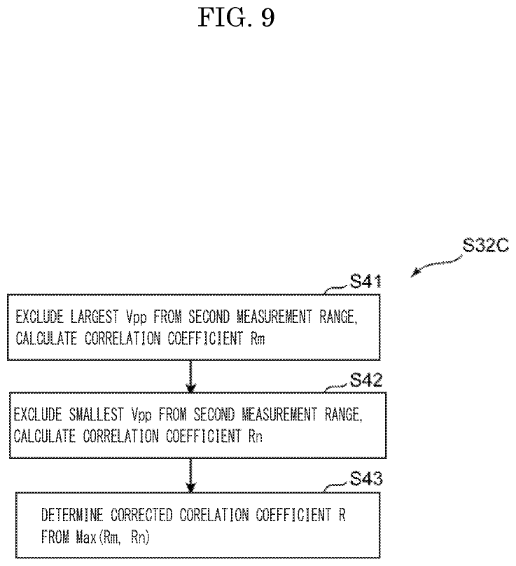

With reference to FIG. 9, when the determination step of the corrected correlation coefficient R is started, in step S41, the calibration performing part 984 calculates the correlation coefficient Rm based on the remaining three data in a state where the data of the largest Vpp is removed from the above four sets of data (step S41). Next, the calibration performing part 984 calculates the correlation coefficient Rn based on the remaining three data in a state where the data of the smallest Vpp is removed from the above four sets of data (step S42). Then, the calculation performing part 984 compares the correlation coefficient Rm with the correlation coefficient Rn, and the larger correlation coefficient is selected as the corrected correlation coefficient R (step S43). Thereafter, with reference to FIG. 8 again, the processing after step S32B is performed based on the corrected correlation coefficient R selected above.

Next, the calibration performing part 984 obtains a linear progression expression (a determination approximate expression, a first determination approximate expression) showing a relationship between the three second measurement peak-to-peak voltages and the three development currents, and calculates the inclination L of the expression (step S33). As an example, the calibration performing part 984 calculates the linear expression by the least squares method, and obtains the inclination L.

Next, the calibration performing part 984 compares the inclination L obtained as described above with the threshold value L1 previously stored in the storage part 983 (step S34). As an example, the threshold L1 is set to 0. If the inclination L is smaller than the threshold value L1 (YES in step 34), the calibration performing part 984 determines that the above linear regression expression is set to the second approximate expression (step S35). On the other hand, if the inclination L is larger than or equal to the threshold value L1 in step S34 (NO in step S34), the calibration performing part 984 calculates the average of the Vpp of the three set of data, and a linear expression in which the average is constant to the change in the peak-to-peak voltage is set to the second approximate expression (step S36).

When the first approximate expression determination step and the second approximate expression determination step shown in FIG. 7 and FIG. 8 are completed, the calibration performing part 984 performs the target voltage determination step (step S13 in FIG. 6). In the target voltage determination step, the calibration performing part 984 determines the peak-to-peak voltage at an intersection where the first approximation expression and the second approximation expression cross each other as a reference peak-to-peak voltage (a target voltage VT, a reference voltage). As a result, the peak-to-peak voltage at the image forming operation can be set near a boundary (near the peak) of the relationships between the peak-to-peak voltage and the development current in the first measurement range and the second measurement range. In this embodiment, a peak-to-peak voltage obtained by multiplying the reference peak-to-peak voltage determined as described above by 1.2, which is set with a predetermined safety factor, is applied as the actual peak-to-peak voltage at the image forming operation.

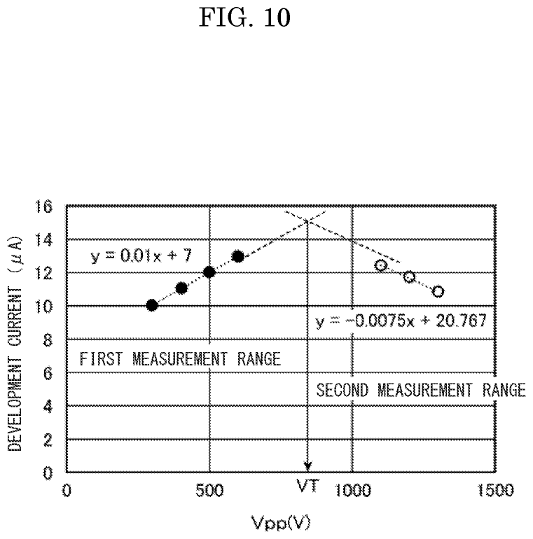

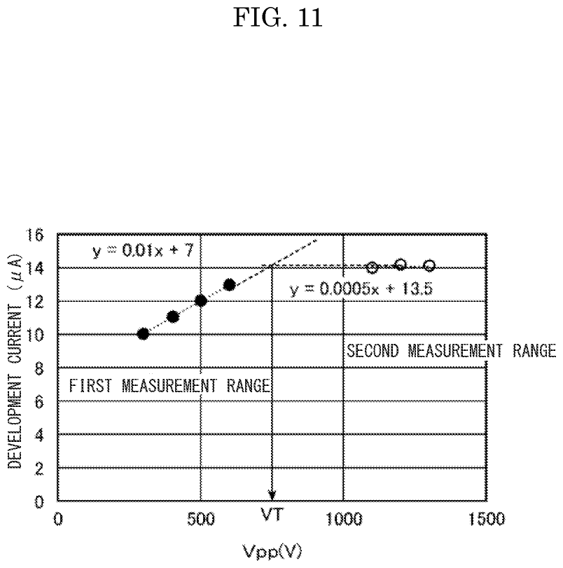

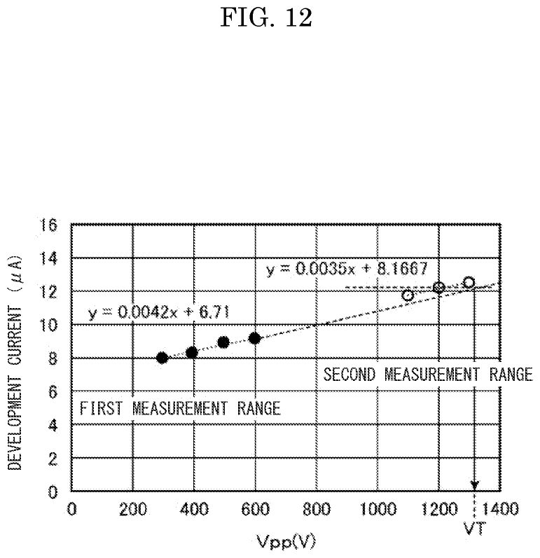

FIG. 10, FIG. 11, and FIG. 12 are graphs showing a relationship between the Vpp and the development current in the AC calibration performed in the image forming apparatus 1 according to the present embodiment. In each drawing, the development current is indicated by a vertical axis (Y axis) and the Vpp is indicated by a horizontal axis (X axis).

Tables 1 and 2 show the relationship between Vpp and the development current in the first measurement range and the second measurement range shown in FIG. 10.

TABLE 1
FIRST MEASUREMENT RANGE

| MEASUREMENT | DEVELOPMENT |
|---|---|
| VOLTAGE | CURRENT |
| Vpp(V) | (μA) |
| 300 | 10 |
| 400 | 11 |
| 500 | 12 |
| 600 | 13 |

TABLE 2
SECOND MEASUREMENT RANGE

| MEASUREMENT | DEVELOPMENT |
|---|---|
| VOLTAGE | CURRENT |
| Vpp(V) | (μA) |
| 1100 | 14 |
| 1200 | 14.2 |
| 1300 | 14.1 |

In FIG. 10, in the first approximate expression determination step shown in FIG. 7, a linear expression of y=0.01 x+7 is calculated as the first approximate expression. On the other hand, in the second approximate expression determination step shown in FIG. 8, since the inclination L is negative (L<L1=0), a linear expression of y=−0.0075 x+20.767 is calculated as the second approximate expression in step S25. As a result, in the target voltage determination step S03, Vpp=the target voltage VT=787 V is calculated as the intersection between the first approximation expression and the second approximation expression, and when 1.2 is set as the safety coefficient, Vpp=787×1.2=944 (V) in the image forming operation is selected.

Tables 3 and 4 show the relationship between the Vpp and the development current in the first measurement range and the second measurement range shown in FIG. 11.

TABLE 3
FIRST MEASUREMENT RANGE

| MEASUREMENT | DEVELOPMENT |
|---|---|
| VOLTAGE | CURRENT |
| Vpp(V) | (μA) |
| 300 | 10 |
| 400 | 11 |
| 500 | 12 |
| 600 | 13 |

TABLE 4
SECOND MEASUREMENT RANGE

| MEASUREMENT | DEVELOPMENT |
|---|---|
| VOLTAGE | CURRENT |
| Vpp(V) | (μA) |
| 1100 | 12.5 |
| 1200 | 11.8 |
| 1300 | 11 |

In FIG. 11, in the first approximate expression determination step shown in FIG. 7, a linear expression of y=0.01 x+7 is calculated as the first approximate expression. On the other hand, in the second approximate expression determination step shown in FIG. 8, since the inclination L is positive (L>L1=0), the average value of the development current is calculated in step S26, and a linear expression of y=14.1 is calculated as the second approximate expression. As a result, in the target voltage determination step S03, Vpp=the target voltage VT=710 V is calculated as the intersection between the first approximation expression and the second approximation expression, and when 1.2 is set as the safety coefficient, Vpp=710×1.2=852 (V) in the image forming operation is selected.

Tables 5 and 6 show the relationship between Vpp and the development current in the first measurement range and the second measurement range shown in FIG. 12.

TABLE 5
FIRST MEASUREMENT RANGE

| MEASUREMENT | DEVELOPMENT |
|---|---|
| VOLTAGE | CURRENT |
| Vpp(V) | (μA) |
| 300 | 8 |
| 400 | 8.3 |
| 500 | 8.9 |
| 600 | 9.2 |

TABLE 6
SECOND MEASUREMENT RANGE

| MEASUREMENT | DEVELOPMENT |
|---|---|
| VOLTAGE | CURRENT |
| Vpp(V) | (μA) |
| 1100 | 12 |
| 1200 | 12.4 |
| 1300 | 12.7 |

In FIG. 12, in the first approximate expression determination step shown in FIG. 7, a linear expression of y=0.0042 x+6.71 is calculated as the first approximate expression. On the other hand, in the second approximate expression determination step shown in FIG. 8, since the inclination L is positive (L>L1=0), the average value of the development current is calculated in step S26, and a linear expression of y=12.4 is calculated as the second approximate expression. As a result, in the target voltage determination step S03, Vpp=target voltage VT=1310 V is calculated as the intersection between the first approximation expression and the second approximation expression, and when 1.2 is set as the safety coefficient, Vpp=1310×1.2=1572 (V) in the image forming operation is selected.

<Reasons Why the Development Current (DC component) has a Peak (Chang point)> Next, the reason why the development current (the DC component) has a peak (the change point) with respect to the Vpp is inferred as in each of the above data. As described above, the development current contains “the toner moving current+the image formed area magnetic brush current+the non-image formed area magnetic brush current”. When obtaining the development current, both “the toner moving current+the image formed area magnetic brush current” flows in the area (the solid image area) corresponding to the image formed area of the electrostatic latent image, but only the “the non-image formed area magnetic brush current” flows in the white background areas at both the end portions in the width direction in the direction opposite to the direction in the image formed area. Therefore, when the Vpp is increased, the non-image formed area magnetic brush current of the white background area is increased, and the total development current is decreased.

The image formed area magnetic brush current of the image formed area increases as the Vpp is increased, but excessive increase of the image formed area magnetic brush current is suppressed because the toner layer formed by the toner supplied to the circumferential surface of the photosensitive drum 20 serves as a resistant layer. On the other hand, in the white background area, some toner is supplied to the surface of the sleeve of the development roller 231, but the amount is much smaller than that of the image formed area, so that the toner layer on the surface of the sleeve does not have a higher resistance than that of the image formed area. As a result, it is inferred that the non-image formed area magnetic brush current in the white background area increases greatly as the increasing of the Vpp, and since this magnetic brush current flows in a direction opposite to the direction of the toner moving current, the development current has a change point (peak).

The inventors of the present disclosure have newly found the above relationship between the development current and the Vpp by repeating intensive experiments. It was further found that this phenomenon is more likely to occur as the resistance of the carrier is lower, and when the resistance value of the carrier is obtained based on the current flowing the carrier of 0.2 g filled between parallel plates (an area of 240 mm²) with a gap of 1 mm applied with 1000 V, this phenomenon is remarkably appeared when the resistance value is 10⁹ ohms or less.

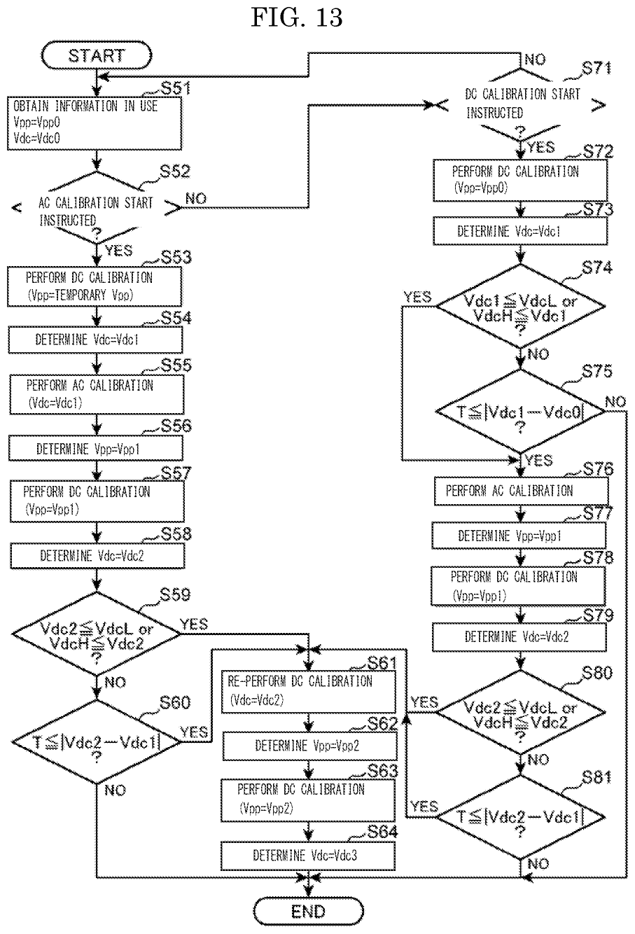

That is, when the two-component developer is filled between the photosensitive drum 20 and the development roller 231, and the measurement electrostatic latent image is formed in the center portion of the electrostatic latent image in the axial direction (the width direction) while the white background areas are formed in both the axial end portions, the above change point occurs at the boundary between the first measurement range and the second measurement range in the present embodiment. Especially, a phenomenon that the inclination of the second approximation equation is distributed in a wide range containing positive and negative is caused because the direction of a current flowing at both the axial end portions of the development roller 231 is opposite to the direction of a current flowing at the center portion. In particular, in the present embodiment, the range of the magnetic brush on the development roller 231 is narrower than the charged range on the photosensitive drum 20 in the axial direction, and the range of the image formed area (the solid image area) of the measurement electrostatic latent image formed on the photosensitive drum 20 is set narrower than the range of the magnetic brush. As a result, as described above, at both the axial end portions of the development roller 231, regions are formed, in which a current flows through the magnetic brush in the direction opposite to the direction of a current flowing through the image formed area. Such a phenomenon is an inherent phenomenon in the development nip area, which cannot occur, for example, in the discharge current generated between the photosensitive drum 20 and the charging roller coming into contact with the circumferential surface of the photosensitive drum 20, and has been found by the above-described repeated experiments. In particular, because the developer in which the resistance of the carrier serves as a changing factor is not filled between the charging roller and the photosensitive drum 20, the characteristic that the current eventually decreases as the peak-to-peak voltage is increased is hardly generated.

<Determination of Re-performing of AC Calibration> As described above, in the present embodiment, the calibration performing part 984 performs the development bias calibration as required during the operation of the image forming apparatus 10. When the potential setting with the highest accuracy is required for the development bias calibration, the development bias calibration includes the first DC calibration, the AC calibration and the second DC calibration (a full specification development bias calibration). On the other hand, when the image forming apparatus 10 performs the image forming operation for a long period of time, the AC calibration and the DC calibration may be performed independently each other without being limited to such development bias calibration. Further, the calibration performing part 984 may determine whether the AC calibration is performed again when the predetermined (second) DC calibration is completed. FIG. 13 is a flowchart showing a state in which the calibration performing part 984 performs the development bias calibration as needed while the image forming operations in the image forming apparatus 10 are sequentially performed. With reference to FIG. 13, a combination of the AC calibration and the DC calibration will be described in further detail.

With reference to FIG. 13, when the image forming operation is performed in the image forming apparatus 10, the calibration performing part 984 obtains in-use information including the peak-to-peak voltage Vpp (hereinafter, called Vpp0) of the AC voltage and the DC voltage Vdc (hereinafter, called Vdc0) of the development bias during the image forming operation (step S51). This information is determined by the past (the latest) DC calibration and AC calibration, and corresponds to the reference DC voltage and the reference peak-to-peak voltage stored in the storage part 983.

Next, the calibration performing part 984 determines whether the start of the AC calibration is instructed (step S52). The start instruction of the AC calibration is determined based on whether the predetermined condition required to perform the AC calibration is satisfied. As an example, at the predetermined timing previously set depending on the time and the number of the printed sheets, or a timing where the change amount of the surround environment (the temperature, the humidity) of the image forming apparatus 10 (the development device 23) exceeds the preset threshold value, the above start instruction is generated.

In step S52, when the calibration start instruction is generated (YES in step S52), the calibration performing part 984 performs the development bias calibration of the above full specification. Therefore, the calibration performing part 984 first performs the first DC calibration (step S53). In this case, the temporary Vpp preset and stored in the storage unit 983 is used as the peak-to-peak voltage of the AC voltage of the development bias. Then, the temporary reference DC voltage Vdc=Vdc1 is determined by the first DC calibration (step S54).

In step S52, when the start of the AC calibration is instructed (YES in step S52), the calibration execution part 984 executes the above full specification development bias calibration. Therefore, the calibration execution part 984 firstly executes the first DC calibration (step S53). In this case, the temporary Vpp preset and stored in the storage part 983 is used as the peak-to-peak voltage of the AC voltage of the development bias. Then, the temporary reference DC voltage Vdc=Vdc1 is determined by the first DC calibration (step S54).

Next, the calibration performing part 984 performs the AC bias calibration (step S55). In this case, the temporary reference DC voltage Vdc1 determined above is used. As a result, the reference peak-to-peak voltage Vpp=Vpp1 is determined (step S56).

Next, the calibration performing part 984 performs the second DC calibration (step S57). In this case, the reference peak-to-peak voltage Vpp1 determined above is used. As a result, the reference DC voltage Vdc=Vdc2 is determined (step S58).

Next, the calibration performing part 984 determines whether the Vdc2 determined above is equal to or smaller than the lower limit value (VdcL: FIG. 5) of the Vdc preset as described above, or whether the Vdc2 is equal to or larger than the upper limit value (VdcH: FIG. 5) of the preset Vdc (step S59). If it is satisfied that VdcL<Vdc2<VdcH (NO in step S59), the calibration performing part 984 determines whether an absolute value of a difference between the temporally reference DC voltage Vdc1 determined by the first DC calibration and the reference DC voltage Vdc2 determined by the second DC calibration is equal to or larger than the preset threshold voltage T (V) (step S60). The determinations in steps S59 and S60 are a process for carefully determining whether the chargeability of the toner is significantly changed in the process of performing each calibration, in other words, whether each bias condition determined by the latest calibration matches the latest chargeability of the toner.

When VdcL<Vdc2<Vdc is not satisfied (YES in step S59) in step S59, or when the absolute value of the difference between Vdc1 and Vdc2 is equal to or larger than the preset threshold voltage T (V) in step S60 (YES in step S60), the calibration performing part 984 performs the AC calibration again in both the cases (step S61). In step S60, when the absolute value of the difference between Vdc1 and Vdc2 is smaller than the preset threshold voltage T (V) (NO in step S60), because each bias condition determined by the latest calibration matches the latest chargeability of the toner, the performing of the development bias calibration is completed.

In step S61, when the AC calibration is performed again, the reference DC voltage Vdc2 determined above is used. As a result, a new reference peak-to-peak voltage Vpp=Vpp2 is determined (step S62).

Next, the calibration performing part 984 performs the DC calibration again (step S63). In this case, the new reference peak-to-peak voltage Vdc=Vdc3 is determined (step S64), and the calibration performing part 984 completes the development bias calibration.

As described in detail later, when the development bias calibration is completed through steps S51 to S55 and S61 in FIG. 13, the chargeability of the toner is unstable and easily changed, in other words, it is often in the middle of the changing process at performing of the DC calibration in step 53 and the AC calibration in step 55. Therefore, the temporary reference DC voltage Vdc1 determined in step S53 may not accurately match the latest chargeability of the toner, and the reference peak-to-peak voltage Vpp1 determined in step S55 is also partially affected by this fact. Therefore, the calibration performing part 984 performs the AC calibration again in step S61 and the DC calibration again in step S63, and the finally determined new reference peak-to-peak voltage Vpp2 and new reference DC voltage Vdc3 are both set to values sufficiently matching the latest chargeability of the toner.

On the other hand, in step S52, when the AC calibration start instruction is not generated, that is, when the conditions for performing the AC calibration are not satisfied, the calibration performing part 984 checks whether the start of the DC calibration is instructed (step S71). For the DC bias calibration, in the same manner as the case of the above AC calibration, the start instruction is generated at a predetermined timing preset depending on the time and the number of printed sheets or at a timing where the change amount of the surrounding environment (the temperature, the humidity) around the image forming apparatus 10 (the development apparatus 23) exceeds a predetermined threshold.

Here, the performing timings of the DC calibration and the AC calibration will be described in detail. Basically, the DC calibration is performed to stabilize the image density in response to the state change of the developer caused by the toner, and the AC calibration is performed to stabilize the image density in response to the state change of the developer caused by the carrier. For example, because the state change of the developer caused by the change in the printing ratio or continuous using and intermittent using are often caused by the toner, the image density is stabilized by the DC calibration. On the other hand, when the number of the printed sheets increases, the influence of the carrier deterioration further occurs, and then the AC calibration is performed.

For example, if an intermittent printing operation of three sheets (an operation in which a job for continuously printing three sheets is repeatedly performed) at an average printing rate of 2% is performed up to 900 sheets, the DC calibration is performed because the effect of the change in the toner is exhibited, and if the intermittent printing operation is performed up to 9000 sheets, the AC calibration is performed because the effect of the change in the carrier is exhibited. In addition, the change in the temperature and humidity condition affects both the toner and the carrier, but because the toner is more subjected to the change, when the change in the temperature and humidity condition is not so large (when the amount of change is smaller than the preset threshold value), the DC calibration is performed first. On the other hand, when the change in the temperature and humidity conditions is large (when the amount of change is equal to or larger than the threshold value), the influence also appears on the carrier, and the AC calibration is performed.

For example, when the image forming apparatus 10 is left for 12 hours in an environment of a temperature of 28° C. and a relative humidity of 80% RH from an environment of a temperature of 23° C. and a relative humidity of 50% RH, the DC calibration is performed to stabilize the image density. On the other hand, when the image forming apparatus 10 is left for 100 hours in an environment of a temperature of 32.5° C. and a relative humidity of 80% RH from an environment of a temperature of 23° C. and a relative humidity of 50% RH, the AC calibration is performed to stabilize the image density.

With reference to FIG. 13 again, if the DC calibration instruction is not generated in step S71 (NO in step S71), the process returns to step S51 to continue the image forming operation. On the other hand, when the DC calibration start instruction is generated in step S71, the calibration performing part 984 performs the DC calibration as it is (step S72). In this case, the Vpp0 obtained in step S51 is used as the peak-to-peak voltage of the AC voltage of the development bias. Then, the reference DC voltage Vdc=Vdc1 is determined by the (first) DC calibration (step S73).

Next, the calibration performing part 984 determines whether the above determined Vdc1 is equal to or smaller than the lower limit value of Vdc (VdcL: FIG. 5) preset described above, or whether the above determined Vdc2 is equal to or larger than the upper limit value of Vdc (VdcH: FIG. 5) preset described above (step S74). If it is satisfied that VdcL<Vdc1<VdcH (NO in step S74), the calibration performing part 984 determines whether an absolute value of a difference between the reference DC voltage Vdc0 determined by the latest DC calibration and the reference DC voltage Vdc1 determined by the current DC calibration is equal to or larger than a preset threshold voltage T (V) (step S75). The determinations in steps S74 and S75 are a process for carefully determining whether the chargeability of the toner is significantly changed after the latest DC calibration is performed, in other words, whether the bias condition determined by the latest DC calibration matches the latest chargeability of the toner.

If VdcL<Vdc1<VdcH is not satisfied in step S74 (YES in step S74), or if the absolute value of the difference between Vdc0 and Vdc1 is equal to or larger than the preset threshold voltage T (V) in step S75 (YES in step S75), the calibration performing part 984 performs the AC calibration again (step S76). If the absolute value of the difference between Vdc0 and Vdc1 in step S75 is smaller than the preset threshold voltage T (V) (NO in step S75), because the bias condition determined by the latest DC calibration matches the latest chargeability of the toner, the calibration performing part 984 completes the performing of the development bias calibration. Although not shown here, in order to further match the bias condition, even if the absolute value of the difference between Vdc0 and Vdc1 is smaller than the predetermined threshold voltage T (V) (NO in step S75), the value of the Vpp may be adjusted without performing the AC calibration depending on a magnitude of the difference between Vdc0 and Vdc1. Specifically, when Vdc1 is increased by A (v) with respect to Vdc0, Vpp is increased by 2×A (V). Thus, the bias condition more matches the latest chargeability of the toner.

In step S76, when the AC calibration is performed again, the reference DC voltage Vdc1 determined above is used. As a result, the new reference peak-to-peak voltage Vpp=Vpp1 is determined (step S77).

Next, the calibration performing part 984 performs the DC calibration again (step S78). In this time, the above determined mew reference peak-to-peak voltage Vpp1 is used. As a result, the new reference DC voltage Vdc=Vdc2 is determined (step S79).

Next, the calibration performing part 984 determines whether the above determined Vdc2 is equal to or smaller than the lower limit value (VdcL: FIG. 5) of the preset Vdc as described above, or whether the above determined Vdc2 is equal to or larger than the upper limit value (VdcH: FIG. 5) of the preset Vdc (step S80). Here, when VdcL<Vdc2<VdcH is satisfied (NO in step S80), the calibration performing part 984 determines whether an absolute value of a difference between the reference DC voltage Vdc1 predetermined by the latest DC calibration and the reference DC voltage Vdc2 determined by the current DC calibration is equal to or larger than the preset threshold voltage T (V) (step S81). The determinations in step S80 and step S81 are process for carefully determining whether the chargeability of the toner is significantly changed after the latest DC calibration is performed, in other words, whether the bias condition determined by the latest DC calibration matches the latest chargeability of the toner.

In step S80, when VdcL<Vdc2<VdcH is satisfied (YES in step S80), or when the absolute value of the difference between Vdc1 and Vdc2 is larger than the preset threshold value T (V) (YES in step S81), in both the cases, the calibration performing part 984 advances the process to the above step S61, and performs the AC calibration again. The processes after step S61 are performed in the above-described manner.

In step S81, when the absolute value of the difference between Vdc1 and Vdc2 is smaller than the preset threshold voltage T (V) (NO in step S81), because the bias condition determined by the latest DC calibration matches the latest chargeability of the toner, the calibration performing part 984 completes the development bias calibration.

As described above, in the present embodiment, when the predetermined condition is satisfied, the calibration performing part 984 performs the development bias calibration (the bias condition determination mode). The development bias calibration contains the first DC calibration (the first DC voltage determination mode), the AC calibration (the peak-to-peak voltage determination mode) performed after the first DC calibration and the second DC calibration (the second DC voltage determination mode) performed after the AC calibration.

The calibration performing part 984 determines the temporally reference DC voltage serving as the temporally reference of the DC voltage of the development bias applied to the development roller 231 based on the density of the measurement toner image detected by the density sensor 100, in the first DC calibration. In addition, in the AC calibration, the calibration performing part 984 determines the reference peak-to-peak voltage serving as the reference of the peak-to-peak voltage of the AC voltage of the development bias applied to the development roller 231 in the image forming operation based on the DC component of the development current measured by the electric current meter 973 when the development bias containing the above temporally reference DC voltage is applied to the development roller 231 to develop the measurement electrostatic latent image using the toner into the measurement toner image. Further, the calibration performing part 984, in the second DC calibration, determines the reference DC voltage serving as the reference of the DC voltage of the development bias applied to the development roller 231 in the image forming operation based on the density of the measurement toner image measured by the density sensor 100 when the development bias containing the peak-to-peak voltage is applied to the development roller 231 to develop the measurement electrostatic latent image using the toner into the measurement toner image.

More specifically, in each DC calibration, the calibration performing part 984 forms a plurality of the measurement toner images on the photosensitive drum 20 while controlling the photosensitive drum 20, the charging device 21, the exposure device 22, and the development device 23. The calibration performing part 984 applies the development bias to the development roller 231 corresponding to the predetermined measurement electrostatic latent image formed on the photosensitive drum 20 to develop the measurement electrostatic latent image using the toner into the measurement toner image, and then transfers the measurement toner image from the photosensitive drum 20 to the intermediate transferring belt 141. Thereafter, based on the density of each measurement toner image on the intermediate transferring belt 141 detected by the density sensor 100, the reference DC voltage serving as the reference of the DC voltage of the development bias applied to the development roller 231 in the image forming operation is determined.

Further, in the first DC calibration, the calibration performing part 984 determines the temporary reference DC voltage serving as the temporary reference of the DC voltage of the development bias referred to the subsequent AC calibration. In the AC calibration performed after the first DC calibration, the above temporary reference DC voltage may be used as it is, or a DC voltage obtained by multiplying the temporary reference DC by a predetermined safety factor may be used. In the image forming operation after the second DC calibration is performed, the above reference DC voltage may be used as it is, or a voltage obtained by multiplying the reference DC voltage by a predetermined safety factor may be used.

According to this configuration, even when the image forming conditions such as a distance (a DS gap) between the development roller 231 and the photosensitive drum 20, the charge amount of the toner, and the resistance of the carrier are changed, the calibration performing part 984 performs the development bias calibration as necessary, so that it becomes possible to set the DC bias and the AC bias (Vpp) according to the image forming conditions. As a result, the DC bias and the peak-to-peak voltages of the DC bias of the development bias, which affect the same image failure, can be stably set, and the image quality can be stabilized and improved.

Further, in the present embodiment, the calibration performing part 984 performs the AC calibration when the absolute value of the difference between the first reference DC voltage, which is the reference DC voltage determined in the (n)th (n is a natural number) DC calibration, and the second reference DC voltage, which is the reference DC voltage determined in the (n+1)th DC calibration, is larger than the preset threshold voltage T (the performing determination threshold).

In the image forming apparatus 10, because the development bias calibration is performed as needed according to the image forming operation, the predetermined DC calibration is expressed as the (n)th and the (n+1)th, as described above. With reference to FIG. 13, in the flow passing through step S55, the DC calibration in step S53 corresponds to the (n)th DC calibration, and the DC calibration in step S57 corresponds to the (n+1)th DC calibration. Then, the calibration performing part 984 performs the determination process based on the threshold voltage T in step S60, and performs the AC calibration in step S61 according to the result.

With reference to FIG. 13, in the flow passing through step S76, the latest DC calibration that determines the Vdc0 obtained in step S51 corresponds to the (n)th DC calibration, and the DC calibration in step S72 corresponds to the (n+1)th DC calibration. Then, the calibration performing part 984 performs the determination process based on the threshold voltage T in step S75, and performs the AC calibration in step S76 according to the result.

Further, the DC calibration in step S72 corresponds to the (n)th DC calibration, and the DC calibration in step S78 corresponds to the (n+1)th DC calibration. Then, the calibration performing part 984 performs the determination process based on the threshold voltage T in step S81, and performs the AC calibration in step S61 according to the result.

As described above, when the absolute value of the difference between the first reference DC voltage and the second reference DC voltage determined in the DC calibrations is larger than the threshold voltage T (larger than or equal to T), the calibration performing part 984 performs the AC calibration, so that it is possible to accurately determine whether the selected reference peak-to-peak voltage corresponds to the latest chargeability of the toner and to re-determine the reference peak-to-peak voltage with higher accuracy if necessary.

Further, in the present embodiment, the (m)th AC calibration is performed between the (n)th DC calibration and the (n+1)th DC calibration (before the (n+1)th DC calibration is performed), and the result is reflected in the (n+1)th DC calibration, so that the development bias calibration with high accuracy can be performed. Further, when the absolute value of the difference between the first reference DC voltage and the second reference DC voltage respectively determined in the (n)th and (n+1)th DC calibrations is larger than the threshold voltage T, the calibration performing part 984 performs the (m+1)th peak-to-peak voltage determination mode, so that it is possible to more accurately determine whether the selected reference peak-to-peak voltage corresponds to the latest chargeability of the toner and to re-determine the reference peak-to-peak voltage with higher accuracy if necessary.

In the image forming apparatus 10, the development bias calibration is performed as needed in accordance with the image forming operation, and the predetermined AC calibration is expressed as the (m)th calibration and the (m+1)th calibration as described above. Here, the AC calibration in step S55 corresponds to the (m)th AC calibration, and the AC calibration in step S61 corresponds to the (m+1)th AC calibration.

The AC calibration in step S76 corresponds to the (m)th AC calibration, and the AC calibration in step S61 corresponds to the (m+1)th AC calibration.

In this embodiment, in the AC calibration (the peak-to-peak voltage determination mode), the reference peak-to-peak voltage is set from the intersection of the first approximate expression and the second approximate expression, in which the first approximate expression represents the relationship between the peak-to-peak voltage of the AC voltage and the development current in the first measurement range and the second approximate expression represents the relationship between the peak-to-peak voltage of the AC voltage and the development current in the second measurement range. Since a change point in the relationships between the peak-to-peak voltage of the AC voltage and the development current exists near the intersection, the inclination of the first approximate expression in the first measurement range is hardly affected, and it becomes possible to suppress the change in the image density due to the variation in the charge amount of the toner and the development gap. Further, it prevents the reference peak-to-peak voltage from being set in a region where the inclination of the second approximate expression is smaller than the predetermined threshold depending on the variation of the resistance of the carrier or the like, and where the development current tends to decrease as the peak-to-peak voltage increases. As a result, it is possible to set the AC voltage of the development bias capable of outputting a stable image density in the image forming operation. The actual peak-to-peak voltage at the image forming operation may be a value of the reference peak-to-peak voltage as it is, a value obtained by multiplying the reference peak-to-peak voltage by a certain ratio, or a value obtained by adding a certain value to the reference peak-to-peak voltage, a value obtained by multiplying the reference peak-to-peak voltage by a certain ratio and then adding a certain value to the multiplied value, a value obtained by increasing (for example, 1 or more) a coefficient to be multiplied for improving pitch unevenness when the reference peak-to-peak voltage is low, or a value obtained by decreasing (for example, less than 1) a coefficient to be multiplied for suppressing leakage when the reference peak-to-peak voltage is high. Further, the upper and lower limits of the actual peak-to-peak voltage at the image forming operation may be determined based on the peak-to-peak voltage (the initial setting value) initially set. At the initial setting, the characteristics are the most stable because the effects of environmental factors and usage history are not included too much. For this reason, it is desirable to set the upper and lower limits of the actual peak-to-peak voltage previously based on the initial setting value so as to avoid a possibility in which the defects such as the pitch unevenness and the leakage may occur in the future.

In the present embodiment, the calibration performing part 984 determines the first approximate expression by the least squares method from the DC components of the development current respectively obtained in the at least three first measurement peak-to-peak voltages included in the first measurement range. According to this configuration, the first approximate expression can be determined from the first measurement peak-to-peak voltage included in the first measurement range by simple arithmetic processing.

In the present embodiment, the calibration performing part 984 sets, as the second approximate expression, the linear expression in which the average value of the DC components of the development currents respectively obtained in the at least three second measurement peak-to-peak voltages included in the second measurement range is constant with respect to the change in the peak-to-peak voltage when the inclination of the first determination approximate expression (a determination approximate expression), which is a linear approximate expression determined by the least squares method from the DC components of the development currents respectively obtained in the at least three measurement second peak-to-peak voltages, is larger than the preset first threshold L1, and sets the first determination approximate expression as the second approximate expression when the inclination of the first determination approximate expression is smaller than the first threshold L1. According to this configuration, in the determination process of the second approximate expression in which the inclination is easily changed due to the influence of the resistance value of the carrier or the like, a more appropriate approximate expression can be selected as the second approximate expression according to the inclination of the first determination approximate expression.

In the present embodiment, the intervals between the plurality of first measurement peak-to-peak voltages in the first measurement range and the intervals between the plurality of second measurement peak-to-peak voltages in the second measurement range are set smaller than the interval between the largest value of the first measurement range and the smallest value of the second measurement range. According to this configuration, the first measurement range and the second measurement range are clearly distinguished, and furthermore, the interval between the peak voltages in each measurement range is finely set, so that the accuracy of determining the first approximate expression and the second approximate expression can be improved.

In the first approximate expression determination processing, when the correlation coefficient of the first approximate expression is smaller than the preset second threshold value, the bias condition determination part determines the first approximate expression based on the DC component of the development current for the remaining peak-to-peak voltages obtained by excluding at least one peak-to-peak voltage from the at least three first measurement peak-to-peak voltages. According to this configuration, when the correlation coefficient is small in the determination process of the first approximate expression, by excluding data of at least one peak-to-peak voltage, the first approximate expression with higher accuracy can be determined.

Especially, the bias condition determination part determines the first approximate expression based on the DC component of the development current for the remaining peak-to-peak voltage obtained by removing the largest peak-to-peak voltage from the at least three first measurement peak-to-peak voltages when the correlation coefficient of the first approximate expression is smaller than the preset threshold value R1 in the first approximate expression determination processing. According to the configuration, when the correlation coefficient is small in the determination process of the first approximate expression, by excluding the peak-to-peak voltage near the second measurement range, the first approximate expression with higher accuracy can be determined.

Further, the bias condition determination part performs the next bias condition determination mode by previously excluding the largest peak-to-peak voltage or the smallest peak-to-peak voltage, which are excluded in the second approximate expression determination processing, from the second measurement range. According to the configuration, the data excluded in the latest bias condition determination mode is previously excluded in the next bias condition determination mode at the beginning, so that it becomes possible to decrease the mode performing period and to determine the reference peak-to-peak voltage with high accuracy.

Further, in the present embodiment, a number of the at least three first measurement peak-to-peak voltages in the first measurement range is set to be larger than a number of the at least three second measurement peak-to-peak voltages in the second measurement range. According to the configuration, a relatively large number of data is obtained in the first measurement range where the inclination of the first approximate expression is positive and the development current is easily changed widely, so that it becomes possible to determine the reference peak-to-peak voltage with higher accuracy.

Further, in the present embodiment, it becomes possible to estimate the change point where a balance of the toner moving current, the image formed area magnetic brush current and the non-image formed area magnetic brush current (a sum of the currents) is changed, using the intersection between the two approximate expressions, and to determine the reference peak-to-peak voltage.

In the present embodiment, the setting of the reference peak-to-peak voltage is determined based on the development current. Conventionally, it is considered that the image density is measured, and the reference peak-to-peak voltage is determined based on the stability of the image density. However, the density sensor measuring the density of the image on the photosensitive drum 20 and the intermediate transferring belt 141 has a property in which the measurement accuracy is easily decreased when the image density is increased, and it is difficult to measure the image density in the second measurement range in the present disclosure with high accuracy. From this point, it is preferable to use the development current as the data for determining the reference peak-to-peak voltage in the first measurement range and the second measurement range.

Further, because the development current tends to change largely in the first measurement range, it is desirable to perform the measurement in a range of the peak-to-peak voltage as wide as possible. On the other hand, in the second measurement range, the change of the development current is relatively small, and if the peak-to-peak voltage is set excessively large, a leak may occur in the development nip area. For this reason, it is desirable that the second measurement range is narrower than the first measurement range and a number of the measurement point is set to be smaller. As a result, it becomes possible to shorten the mode performing time and to suppress the increase in the amount of toner consumed.

The development current may be measured in a circuit in the development bias applying part 971. Although the tone moving current can be measured on the side of the photosensitive drum 20, the photosensitive drum 20 is applied with a current flowing from the transferring roller, and these currents cannot be separated. Therefore, the development current is preferably measured on the side of the development bias applying part 971.

In the present embodiment, in the first and second DC calibrations (the first DC voltage determination mode and the second DC voltage determination mode), the calibration performing part 984 applies the development bias to the development roller 231 under the conditions in which the DC voltage of the development bias is set to each of the DC measurement voltages, develops the measurement electrostatic latent images into the measurement toner images, obtains the density of each of the measurement toner images by the density sensor 100, and determines the DC voltage corresponding to the predetermined target density as the temporary reference DC voltage or the reference DC voltage, based on the relationship between the plurality of measurement DC voltages and the densities of the plurality of measurement toner images.

According to such a configuration, the DC voltage corresponding to the predetermined target density can be easily determined as the temporal reference DC voltage or the reference DC voltage based on the relationship between the plurality of measurement DC voltages and the densities of the plurality of measurement toner images.

In the modified embodiment, as shown in FIG. 8 and FIG. 9, when the correlation coefficient is small in the second approximate expression determination step, the data having a high correlation coefficient is selected, and the second approximate expression is set based on the selected data. Therefore, by excluding the data of at least one peak-to-peak voltage, the second approximate expression with higher accuracy can be determined.

In particular, the calibration performing part 984 compares the correlation coefficient Rm of the second determination approximate expression with the correlation coefficient Rn of the third determination approximate expression. Here, the second determination approximate expression is determined based on the DC component of the development current for the remaining peak-to-peak voltages obtained by excluding the largest peak-to-peak voltage from the at least three second measurement peak-to-peak voltages, and the third determination approximate expression is determined based on the DC component of the development current for the remaining peak-to-peak voltages obtained by excluding the smallest peak-to-peak voltage from the at least three second measurement peak-to-peak voltages. Then, the calibration performing part 984 determines the determination approximate expression having the larger correlation coefficient among the second determination approximate expression and the third determination approximate expression as the second approximate expression. According to this configuration, when the correlation coefficient is small in the determination process of the second approximate expression, the second approximate expression with higher accuracy can be determined by excluding any of the data of the smallest peak-to-peak voltage closest to the first measurement range in the second measurement range or the data of the largest peak-to-peak voltage likely to cause discharge leakage and to include noise.

Although the embodiments of the present disclosure have been described above, the present disclosure is not limited thereto, and for example, the following modified embodiments may be employed.

(1) Although the above embodiment has been described in the manner in which the surface of the development roller 231 is subjected to knurling and blasting, the surface of the development roller 231 may have a concave shape (dimple) and be subjected to blasting, or may be subjected to only blasting, only knurling, and only concave shape (dimple) forming, or plating.

(2) In the case where the image forming apparatus 10 has a plurality of development devices 23 as shown in FIG. 1, the AC calibration according to the embodiment may be performed in one or two development devices 23, and the result may be utilized for another development device 23.

(3) In the AC bias calibration according to the above embodiment, the example where the reference peak-to-peak voltage is set from the intersection of the first approximate expression and the second approximate expression representing the relationship between the peak-to-peak voltage (Vpp) of the AC voltage and the development current. This disclosure is not limited to the example. When the development current is measured corresponding to each Vpp when the measurement electrostatic latent image is developed into the measurement toner image while changing the Vpp in the same manner as described above, the graph is obtained which shows the relationship where the development current increases as the Vpp increases to form a predetermined maximum value and then decreases. Here, the calibration performing part 984 may determine the reference peak-to-peak voltage by obtaining the Vpp at which the development current becomes maximum, or may determine the reference peak-to-peak voltage by obtaining the Vpp at which the inclination of the tangent of the above graph becomes 0. In the AC calibration according to the above embodiment, the measurement image is formed using the solid image, but the measurement image may be formed using a halftone image. Further, the density of the measurement image of the halftone image may be detected by the density sensor 100, and the peak-to-peak voltage for obtaining the predetermined image density may be determined as the reference peak-to-peak voltage based on the relationship between the plurality of peak-to-peak voltages and the corresponding plurality of image densities.

As described above, in the AC calibration (the peak-to-peak voltage determination mode), the calibration performing part 984 obtains the DC component of the development current detected by the electric current meter 973 when the development current is applied to the development roller 231 under the conditions where the peak-to-peak voltage of the AC component of the development current is set for each of the measurement peak-to-peak voltages to develop the measurement electrostatic latent image into the measurement toner image, and determines the reference peak-to-peak voltage from the relationship between the plurality of peak-to-peak measurement voltages and the plurality of DC components of the development current. Therefore, the reference peak-to-peak voltage can be easily determined from the relationship between the plurality of peak-to-peak measurement voltages and the DC components of the plurality of development currents.

In the AC calibration, the calibration performing part 984 may determine, as the reference peak-to-peak voltage, the peak-to-peak voltage corresponding to the largest value of the DC component of the development current in the graph representing the relationship between the plurality of peak-to-measurement voltages and the DC components of the plurality of development currents. In this case, since the peak-to-peak voltage corresponding to the largest value of the DC component of the development current is determined as the reference peak-to-peak voltage, the reference peak-to-peak voltage can be easily determined.

In the AC calibration, the calibration performing part 984 may determine, as the reference peak-to-peak voltage, the peak-to-peak voltage corresponding to a point where the inclination in the graph representing the relationship between the plurality of peak-to-measurement voltages and the DC components of the plurality of development currents becomes 0. In this case, since the peak-to-peak voltage corresponding to the point where the inclination in the graph representing the relationship between the plurality of peak-to-peak measurement voltages and the DC components of the plurality of developing currents becomes zero is determined as the reference peak-to-peak voltage, the reference peak-to-peak voltage can be easily determined.

### Example

Hereinafter, the development bias calibration according to the present embodiment will be described in detail based on the data. The following data were obtained under the following conditions.

<Common Condition>

A printing speed: 55 sheets per minute;

The photosensitive drum 20: an amorphous silicon photosensitive drum (α-Si);

The development roller 231: an outer diameter 20 mm, a surface structure subjected to knurled groove processing and blast processing (80 rows of recesses (grooves) are formed along the circumferential direction);

The regulating Blade 234: made of SUS 430, magnetic, 1.5 mm thickness;

An conveyance amount of the developer after the developer is passed the regulating blade 234: 250 g/m²;

A circumferential speed of the development roller 231 with respect to the photosensitive drum 20: 1.8 (in the trail direction at the facing position);

A distance between the photosensitive drum 20 and the development roller 231: 0.25 mm;

A white area (a background area) potential of the photosensitive drum 20 V0: +250 V

An image formed potential of the photosensitive drum 20 VL: +10 V

A development bias of the development roller 231: An AC voltage rectangular wave having a frequency of 10 kHz and a duty of 50% (Vpp is adjusted according to each experimental condition), Vdc (DC voltage)=150 V;

The toner: a positive charge polarity toner, a volume average particle diameter 6.8 μm, a toner concentration 6%; and

The Carrier: a volume average particle size 35 μm, ferrite/resin-coated carrier.

<Developer> The same effect is confirmed whether the toner is a pulverized toner or a toner having a core-shell structure. It was also confirmed that the same effect can be obtained in the toner concentration range from 3% to 12%. Since the movement of the toner by the AC electric field remarkably occurs as the magnetic brush is finer, the volume average particle diameter of the carrier is preferably 45 μm or less, more preferably 30 μm or more and 40 μm or less. A resin carrier having a smaller true specific gravity than a ferrite carrier is more preferable.

<Carrier> The carrier was formed by coating a ferrite core having a volume average particle diameter of 35 μm with silicon, fluorine, or the like, concretely by the following procedure. A coating liquid was prepared by dissolving 1000 parts by weight of a carrier core EF-35 (made by Powdertech Co.) and 20 parts by weight of a silicon resin KR-271 (made by Shinetsu Chemical Co.) in 200 parts by weight of toluene. Then, the coating liquid was sprayed and applied by a fluidized bed coating apparatus, and then was heat-treated at 200° C. for 60 minutes to obtain the carrier. In this coating liquid, a conductive agent and a charge control agent were mixed and dispersed in a range of 0 to 20 parts with respect to 100 parts of the coating resin, to adjust the resistance and the charge.

<Evaluation Results> Tables 7, 8, 9, 10, and 11 show the results of experiments of Comparative Example, Example 1, Example 2, Example 3, and Example 4, respectively, under the above experimental conditions. In each table, the predetermined processing is performed as time elapses from the left side to the right.

TABLE 7

| | Normal | High: temperature | Normal temperature | | | | |
|---|---|---|---|---|---|---|---|
| Environment | temperature | High: humidity | Calibration | | | | |
| Operation | Printing | Stop | DC Calib. | AC Calib. | DC Calib. | Re-AC Calib. | DC Calib. |
| Vpp(V) | 1200 | | 1000 | 920 | 920 | | |
| Vdc(V) | 118 | | 84 | 84 | 116 | | |

TABLE 8

| | Normal | High: temperature | Normal temperature | | | | |
|---|---|---|---|---|---|---|---|
| Environment | temperature | High: humidity | Calibration | | | | |
| Operation | Printing | Stop | DC Calib. | AC Calib. | DC Calib. | Re-AC Calib. | DC Calib. |
| Vpp(V) | 1200 | | 1000 | 920 | 920 | 1030 | 1030 |
| Vdc(V) | 118 | | 84 | 84 | 116 | 116 | 92 |

TABLE 9

| | Normal | High: temperature | Normal temperature | | | | |
|---|---|---|---|---|---|---|---|
| Environment | temperature | High: humidity | Calibration | | | | |
| Operation | Printing | Stop | DC Calib. | AC Calib. | DC Calib. | Re-AC Calib. | DC Calib. |
| Vpp(V) | 1200 | | 1000 | 920 | 920 | | |
| Vdc(V) | 118 | | 84 | 84 | 96 | | |

TABLE 10

| | Normal | High temperature | Normal temperature | | | | |
|---|---|---|---|---|---|---|---|
| Environment | temperature | High humidity | Calibration | | | | |
| Operation | Printing | Stop | DC Calib | AC Calib. | DC Calib. | Re-AC Calib. | DC Calib. |
| Vpp(V) | 1200 | | 1200 | 960 | 960 | | |
| Vdc(V) | 118 | | 77 | 77 | 92 | | |

TABLE 11

| | Normal | High: temperature | Normal temperature | | | | |
|---|---|---|---|---|---|---|---|
| Environment | temperature | High: humidity | Calibration | | | | |
| Operation | Printing | Stop | DC Calib. | AC Calib. | DC Calib. | Re-AC Calib. | DC Calib. |
| Vpp(V) | 1200 | | 1200 | 960 | 960 | 1050 | 1050 |
| Vdc(V) | 118 | | 77 | 77 | 108 | 108 | 94 |

In each experiment, first, an intermittent printing of five sheets was performed at a printing rate of 5% as the printing before the calibration at room temperature. At this time, Vpp=1200 (V) and Vdc=118 (V) are commonly set for each experiment. Thereafter, the image forming apparatus 10 is left for a predetermined time (for example, overnight) in a high-temperature and high-humidity environment. Thereafter, a predetermined calibration is performed at normal temperature according to each experimental condition.

Specifically, in the Comparative example of Table 7, the AC calibration re-performing processing as shown in FIG. 13 is not included, and the DC calibration, the AC calibration and the DC calibration are sequentially performed. In the Examples 1 to 4 of Tables 8 to 11, the AC calibration re-performing processing of FIG. 13 is performed as needed.

In each experiment, when the image forming apparatus 10 is left under a high-temperature and high-humidity environment, the charge amount of the developer decreases. However, this decrease is not caused by the fundamental decrease in the charging characteristics of the developer, but is a temporary decreasing caused by the high-temperature and high-humidity environment. Therefore, the charge amount of the toner gradually returns in the subsequent printing operation at normal temperature. However, if the decreasing and returning of the charge amount of the toner are overlooked, a development bias condition (Vdc, Vpp) that does not match the latest charging characteristic of the developer is set, and the image forming with high image quality is impaired. The experiments shown in Tables 7 to 11 explain this point.

Specifically, in the Comparative example shown in Table 7, the development performance is heightened because the charge amount of the toner is decreased under the leaving environment, and Vdc=84 (V) is set as the temporary reference DC voltage in the first DC calibration. As Vpp at the time of performing the DC calibration, Vpp=1000 (V) previously stored in the storage part 983 is used. The AC calibration after the first DC calibration is performed using the temporary reference DC voltage 84 (V) set as described above, and the temporary reference peak-to-peak voltage Vpp=920 (V) is determined. Further, the subsequent second DC calibration is performed using the temporary peak-to-peak voltage 920 (V), and the reference DC voltage Vdc=116 (V) is determined. Since the combination of the reference peak-to-peak voltage Vpp=920 (V) and the reference DC voltage Vdc=116 (V) is set under the influence of the low chargeability of the toner after being left, if the chargeability of the toner stirred in the development device 23 is increased in the image forming operation at normal temperature thereafter, it becomes difficult to perform sufficient development, and low ID, that is, insufficient image density, is likely to occur.

The Example 1 shown in Table 8 corresponds to the flow in FIG. 13 in which the step proceeds to steps S53, S55, S57, S61, and S63. Specifically, in the same manner as in the above Comparative example, since the charge amount of the toner is decreased under the leaving environment, the development performance is heightened, and Vdc=84 (V) is set as the temporary reference DC voltage in the first DC calibration, and in the AC calibration performed after the first DC calibration, the reference peak-to-peak voltage Vpp=920 (V) is determined. Further, in the subsequent second DC calibration, the reference DC voltage Vdc=116 (V) is determined. Therefore, in step S60 in FIG. 13, since the absolute value of the difference between the reference DC voltage Vdc2 and the temporary reference DC voltage Vdc1 is 32 (V) and exceeds the preset threshold voltage T=30 (V), the AC calibration is performed again in step S61. At this time, the reference DC voltage Vdc=116 (V) is used to set a new reference peak-to-peak voltage Vpp2=1030 (V). Then, in step S63, the DC calibration is performed again using the new reference peak-to-peak voltage Vpp2, and a new reference DC voltage Vdc3=92 (V) is determined. As a result, as compared with the Comparative example, a larger peak-to-peak voltage is set, and a good image density can be secured even in the toner with the increased charge amount.

In the second Example shown in Table 9, the step proceeds to steps S53, S55, S57 and S60 in FIG. 13, this corresponds to the flow in which the development bias calibration is completed as it is. Specifically, in the same manner as in the Comparative example, since the charge amount of the toner is decreased under the leaving environment, the development performance is heightened, and Vdc=84 (V) is set as the temporary reference DC voltage in the first DC calibration, and in the AC calibration performed after the first DC calibration, the reference peak-to-peak voltage Vpp=920 (V) is determined. Further, in the subsequent second DC calibration, the reference DC voltage Vdc=96 (V) is determined. Therefore, in step S60 in FIG. 13, since the absolute value of the difference between the reference DC voltage Vdc2 and the temporary reference DC voltage Vdc1 is 12 (V) and does not exceed the preset threshold voltage T=30 (V), the development bias calibration is completed as it is. In such an example, since the chargeability of the toner does not change as much as in the Example 1 between the first DC calibration and the second DC calibration, sufficient image density can be ensured even in the subsequent image forming operations. In other words, since it is not necessary to perform the additional calibration as in the first Example for the chargeability of the toner, it is possible to quickly shift to the next image forming operation.

In the third Example shown in Table 10, the step proceeds to steps S52, S71, S72, S76 and S81 in FIG. 13, and this corresponds to the flow in which the development bias calibration is completed as it is. Specifically, in the same manner as in the Comparative example described above, since the charge amount of the toner is decreased under the leaving environment, the development performance is heightened, and in the first DC calibration in step S72, Vdc1=77 (V) is set as the reference DC voltage. In this case, Vpp=1200 (V) obtained in step S51 is used as the peak-to-peak voltage during the DC calibration. The set reference DC voltage Vdc1=77 (V) has a potential difference of 41 (V) with respect to the DC voltage Vdc0=118 (V) used for the image forming operation at room temperature before being left, and exceeds the threshold voltage T=30 (V). Therefore, the AC calibration is performed in step S76 after the first DC calibration, and the reference peak-to-peak voltage Vpp=960 (V) is determined. Further, in the subsequent second DC calibration, the reference DC voltage Vdc=92 (V) is determined. Therefore, in step S81 in FIG. 13, since the absolute value of the difference between the reference DC voltage Vdc2 and the reference DC voltage Vdc1 is 15 (V) and does not exceed the preset threshold voltage T=30 (V), the development bias calibration is completed as it is. Even in such an example, since it is not necessary to perform the additional calibration, it is possible to quickly shift to the next image forming operation.

Further, in the Example 4 shown in Table 11, the step proceeds to steps S52, S71, S72, S76, S81, S61 and S63 in FIG. 13, and this corresponds to the flow in which the development bias calibration is completed. Specifically, in the same manner as in the Comparative example described above, since the charge amount of the toner is decreased under the leaving environment, the development performance is heightened, and in the first DC calibration in step S72, Vdc1=77 (V) is set as the reference DC voltage. In this case, Vpp=1200 (V) obtained in step S51 is used as the peak-to-peak voltage during the DC calibration. In the case of the set reference DC voltage Vdc1=77 (V), there is a potential difference of 41 (V) with respect to the DC voltage Vdc0=118 (V) used for the image forming operation at room temperature before being left, and the potential difference exceeds the threshold voltage T=30 (V). Therefore, the AC calibration is performed in step S76 after the first DC calibration, and the reference peak-to-peak voltage Vpp=960 (V) is determined. In the subsequent second DC calibration, the reference DC voltage Vdc=108 (V) is determined. Therefore, in step S81 in FIG. 13, since the absolute value of the difference between the reference DC voltage Vdc2 and the reference DC voltage Vdc1 is 31 (V) and exceeds the preset threshold voltage T=30 (V), the AC calibration is performed again in step S61. At this time, the reference DC voltage Vdc=108 (V) is used to set a new reference peak-to-peak voltage Vpp2=1050 (V). In step S63, the DC calibration is performed again using the new reference peak-to-peak voltage Vpp2, and a new reference DC voltage Vdc3=94 (V) is determined. Also in this case, as compared with the Comparative example, a larger peak-to-peak voltage is set, and good image density can be secured even in the toner with the increased charge amount.

As described above, in the development bias calibration including the re-performing processing of the AC calibration according to the present disclosure, since the AC calibration is performed again as needed, the optimum Vdc and Vpp according to the charge amount of the toner are set and the image quality is maintained high.

The present disclosure may be changed, substituted, or modified in various ways without departing from the spirit of the technical idea, and the claims include all embodiments which may be included within the scope of the technical idea.

1. An image forming apparatus capable of performing an image forming operation in which an image is formed on a sheet, the image forming apparatus comprising:
an image carrier provided to be rotated and having a surface on which an electrostatic latent image can be formed and a toner image formed by developing the electrostatic latent image with a toner is carried;
a charging device which charges the image carrier at a predetermined charged potential;
an exposure device which is disposed on a downstream side of the charging device in a rotational direction of the image carrier and exposes the surface of the image carrier charged to the charged potential according to predetermined image information to form the electrostatic latent image;
a development device which is disposed so as to face the image carrier at a predetermined development nip area on a downstream side of the exposure device in the rotational direction and includes a rotatable development roller having a circumferential surface carrying a developer containing the toner and a carrier, the development roller supplying the toner to the image carrier to form the toner image;
a transferring part which transfers the toner image carried on the image carrier to the sheet;
a development bias applying part capable of applying a development bias containing a DC voltage on which an AC voltage is superposed;
an electric current detection part capable of detecting a DC component of a development current flowing between the development roller and the development bias applying part;
a density detection part capable of detecting a density of the toner image; and
a bias condition determination part performing a bias condition determination mode in which, when the development bias is applied to the development roller corresponding to a predetermined measurement electrostatic latent image formed on the image carrier to develop the measurement electrostatic latent image into a measurement toner image, based on the DC component of the development current detected by the electric current detection part or the density of the measurement toner image detected by the density detection part, reference voltages serving as references of a peak-to-peak voltage of the AC voltage and the DC voltage of the development bias applied to the development roller in the image forming operation are determined, wherein
the bias condition determination part can perform a DC voltage determination mode and a peak-to-peak voltage determination mode as the bias condition determination mode, wherein
the DC voltage determination mode determines the reference DC voltage serving as the reference of the DC voltage of the development bias applied to the development roller based on the density of the measurement toner image detected by the density detection part, and
the peak-to-peak-voltage determination mode determines the reference peak-to-peak voltage serving as the reference of the peak-to-peak voltage of the AC voltage of the development bias applied to the development roller in the image forming operation, based on the DC component of the development current detected by the electric current detection part or the density of the measurement toner image detected by the density detection part when the development bias corresponding to the reference DC voltage is applied to the development roller to develop the measurement electrostatic latent image with the toner into the measurement toner image, and
the peak-to-peak voltage determination mode is performed when an absolute value of a difference between a first reference DC voltage which is the reference DC voltage determined in the (n)th DC voltage determination mode (n is a natural number) and a second reference DC voltage which is the reference DC voltage determined in (n+1)th DC voltage determination mode is larger than a preset performing determination threshold value.

2. The image forming apparatus according to claim 1, wherein
the bias condition determination part performs the (m)th peak-to-peak voltage determination mode (m is a natural number) by applying the development bias including the first reference DC voltage to the development roller after the (n)th DC voltage determination mode is performed and before the (n+1)th DC voltage determination mode is performed,
performs the (n+1)th DC voltage determination mode by applying the development bias including the reference peak-to-peak voltage determined in the (m)th peak-to-peak voltage determination mode to the development roller, and
performs the (m+1)th peak-to-peak voltage determination mode when an absolute value of a difference between the first reference DC voltage determined in the (n)th DC voltage determination mode and the second reference DC voltage determined in the (n+1)th DC voltage determination mode is larger than the preset performing determination threshold value.

3. The image forming apparatus according to claim 1, wherein
the bias condition determination part performs a first approximate expression determination processing, a second approximate expression determination processing and a reference voltage determination processing in the peak-to-peak voltage determination mode, wherein
in the first approximate expression determination processing, the DC component of the development current is obtained under each of conditions where the peak-to-peak voltage of the AC component of the development bias is set to at least three first measurement peak-to-peak voltages contained in a predetermined first measurement range, and a first approximate expression which is a linear expression representing a relationship between the first measurement peak-to-peak voltage in the first measurement range and the obtained DC component of the development current is determined,
in the second approximate expression determination processing, the DC component of the development current is obtained under each of conditions where the peak-to-peak voltage of the development bias is set to at least three second measurement peak-to-peak voltages contained in a second measurement range which is set to have a smallest value larger than a largest value of the first measurement range, and a second approximate expression which is a linear expression representing a relationship between the second measurement peak-to-peak voltage in the second measurement range and the obtained DC component of the development current is determined, and
in the reference voltage determination processing, a peak-to-peak voltage at an intersection where the first approximate expression determined by the first approximate expression determination processing and the second approximate expression determined by the second approximate expression determination processing are crossed each other is determined as the reference peak-to-peak voltage.

4. The image forming apparatus according to claim 3, wherein
the bias condition determination part determines the first approximate expression by the least squares method from the DC components of the development currents obtained in the at least three first measurement peak-to-peak voltages included in the first measurement range.

5. The image forming apparatus according to claim 4, wherein
when an inclination of a determination approximate expression, which is a linear approximate expression determined by the least squares method from the DC components of the development currents obtained in the at least three second measurement peak-to-peak voltages included in the second measurement range, is larger than a preset first threshold, the bias condition determination part sets, as the second approximation expression, a linear expression in which an average value of the DC components of the development currents obtained in the at least three second measurement peak-to-peak voltages is constant with respect to a change in the peak-to-peak voltage, and
when the inclination of the determination approximate expression is smaller than the preset first threshold, the bias condition determination part sets the determination approximate expression as the second approximate expression.

6. The image forming apparatus according to claim 3, wherein
the bias condition determination part obtains a change point, at which a balance of three currents constituting the DC component of the development current is changed depending on a change in the peak-to-peak voltage, by the intersection of the first approximate expression and the second approximate expression, wherein
the three currents include a toner moving current, an image formed area magnetic brush current and a non-image formed area magnetic brush current, wherein
the toner moving current is a current generated by a movement of the toner from the development roller to the image carrier in an image formed area of the development nip area, the image formed area magnetic brush current is a current flowing in the same direction as the toner moving current along a magnetic brush formed by the toner and the carrier between the development roller and the image carrier in the image formed area, and the non-image formed area magnetic brush current is a current flowing in an opposite direction to the toner moving current along the magnetic brush formed by the toner and the carrier between the development roller and the image carrier in a non-image formed area of the development nip area, and
determines the peak-to-peak voltage corresponding to the change point as the reference peak-to-peak voltage.
